(19) United States
(12) Patent Application Publication
(10) Pub. No.: US 2017/0019915 A1
(43) Pub. Date: Jan. 19, 2017

(54) USER EQUIPMENTS, BASE STATIONS AND METHODS FOR LICENSE ASSISTED ACCESS (LAA)

(71) Applicant: Sharp Laboratories of America, Inc., Camas, WA (US)

(72) Inventors: Toshizo Nogami, Vancouver, WA (US); Zhanping Yin, Vancouver, WA (US)

(21) Appl. No.: 15/211,442

(22) Filed: Jul. 15, 2016

Related U.S. Application Data
(60) Provisional application No. 62/194,154, filed on Jul. 17, 2015.

(51) Int. Cl. H04W 72/12; H04L 29/06

(52) U.S. Cl. CPC H04W 72/1273; H04L 69/22; H04W 88/02

(57) ABSTRACT

A first serving cell and a second serving cell are configured. A first physical downlink control channel (PDCCH) or a first enhanced PDCCH (EPDCCH) with a first downlink control information (DCI) format for scheduling a first physical downlink shared channel (PDSCH) on the first serving cell is transmitted and/or monitored. A second PDCCH or a second EPDCCH with a second DCI format for scheduling a second PDSCH on the second serving cell is transmitted and/or monitored. The first DCI format includes a first field indicating a first resource block assignment for the first PDSCH and a second field indicating at least one of first PDSCH starting and ending positions. The second DCI format includes a third field indicating a second resource block assignment for the second PDSCH. A total bit size of the first and second fields is smaller than or equal to that of the third field.

### RELATED APPLICATIONS

This application is related to and claims priority from U.S. Provisional Patent Application No. 62/194,154, entitled “USER EQUIPMENTS, BASE STATIONS AND METHODS FOR LICENSE ASSISTED ACCESS (LAA),” filed on Jul. 17, 2015, which is hereby incorporated by reference herein, in its entirety.

### TECHNICAL FIELD

The present disclosure relates generally to communication systems. More specifically, the present disclosure relates to user equipments (UEs), base stations and methods.

### BACKGROUND

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of wireless communication devices, each of which may be serviced by a base station. A base station may be a device that communicates with wireless communication devices.

As wireless communication devices have advanced, improvements in communication capacity, speed, flexibility and/or efficiency have been sought. However, improving communication capacity, speed, flexibility and/or efficiency may present certain problems.

For example, wireless communication devices may communicate with one or more devices using a communication structure. However, the communication structure used may only offer limited flexibility and/or efficiency. As illustrated by this discussion, systems and methods that improve communication flexibility and/or efficiency may be beneficial.

### BRIEF DESCRIPTION OF THE DRAWINGS

FIG. 1 is a block diagram illustrating one implementation of one or more evolved NodeBs (eNBs) and one or more user equipments (UEs) in which systems and methods for licensed assisted access (LAA) may be implemented;

FIG. 2 is block diagram illustrating a detailed configuration of an eNB and a UE in which systems and methods for LAA may be implemented;

FIG. 3 is a flow diagram illustrating a method for LAA by a UE;

FIG. 4 is a flow diagram illustrating a method for LAA by an eNB;

FIG. 5 is a diagram illustrating one example of a radio frame that may be used in accordance with the systems and methods disclosed herein;

FIG. 6 is a diagram illustrating one example of a resource grid;

FIG. 7 is a diagram illustrating an example of interlaced PRB assignment;

FIG. 8 is a diagram illustrating an example of a downlink transmission burst;

FIG. 9 illustrates various components that may be utilized in a UE;

FIG. 10 illustrates various components that may be utilized in an eNB;

FIG. 11 is a block diagram illustrating one implementation of a UE in which systems and methods for performing LAA may be implemented; and

FIG. 12 is a block diagram illustrating one implementation of an eNB in which systems and methods for performing LAA may be implemented.

### DETAILED DESCRIPTION

A user equipment (UE) is described. The UE includes a higher layer processor configured to configure a first serving cell and a second serving cell. The UE also includes a control channel receiver configured to monitor a first physical downlink control channel (PDCCH) or a first enhanced physical downlink control channel (EPDCCH) with a first downlink control information (DCI) format for scheduling a first physical downlink shared channel (PDSCH) on the first serving cell and to monitor a second PDCCH or a second EPDCCH with a second DCI format for scheduling a second PDSCH on the second serving cell. The first DCI format includes a first field indicating a first resource block assignment for the first PDSCH and a second field indicating at least one of first PDSCH starting and ending positions. The second DCI format includes a third field indicating a second resource block assignment for the second PDSCH. A total bit size of the first field and the second field is smaller than or equal to a bit size of the third field. A size of the first DCI format may be the same as a size of the second DCI format.

The second field may indicate a combination of the starting position and the ending position of the first PDSCH from a plurality of predefined combinations. The second field may include a first sub field and a second sub field. The first sub field may indicate the starting position of the first PDSCH. The second sub field may indicate the ending position of the first PDSCH.

The second field may include a first sub field and a second sub field. The first sub field may indicate a subframe type. The second sub field may indicate one of a starting position and an ending position of the first PDSCH.

An evolved NodeB (eNB) is also described. The eNB includes a higher layer processor configured to configure, to a user equipment (UE), a first serving cell and a second serving cell. The eNB also includes a physical downlink control channel transmitter configured to transmit a first physical downlink control channel (PDCCH) or a first enhanced physical downlink control channel (EPDCCH) with a first downlink control information (DCI) format for scheduling a first physical downlink shared channel (PDSCH) on the first serving cell and to transmit a second PDCCH or a second EPDCCH with a second DCI format for scheduling a second PDSCH in the second serving cell. The first DCI format includes a first field indicating a first resource block assignment for the first PDSCH and a second field indicating at least one of first PDSCH starting and ending positions. The second DCI format includes a third field indicating a second resource block assignment for the second PDSCH. A total bit size of the first field and the second field is smaller than or equal to a bit size of the third field. A size of the first DCI format may be the same as a size of the second DCI format.

The second field may indicate a combination of the starting position and the ending position of the first PDSCH from a plurality of predefined combinations. The second field may include a first sub field and a second sub field. The first sub field may indicate the starting position of the first PDSCH. The second sub field may indicate the ending position of the first PDSCH.

The second field may include a first sub field and a second sub field. The first sub field may indicate a subframe type. The second sub field may indicate one of a starting position and an ending position of the first PDSCH.

A method by a user equipment (UE) is also described. The method includes configuring a first serving cell. The method also includes configuring a second serving cell. The method further includes monitoring a first physical downlink control channel (PDCCH) or a first enhanced physical downlink control channel (EPDCCH) with a first downlink control information (DCI) format for scheduling a first physical downlink shared channel (PDSCH) on the first serving cell. The method additionally includes monitoring a second PDCCH or a second EPDCCH with a second DCI format for scheduling a second PDSCH on the second serving cell. The first DCI format includes a first field indicating a first resource block assignment for the first PDSCH and a second field indicating at least one of first PDSCH starting and ending positions. The second DCI format includes a third field indicating a second resource block assignment for the second PDSCH. A total bit size of the first field and the second field is smaller than or equal to a bit size of the third field.

A method by an evolved Node B (eNB) is also described. The method includes configuring, to a user equipment (UE), a first serving cell. The method also includes configuring, to the UE, a second serving cell. The method further includes transmitting a first physical downlink control channel (PDCCH) or a first enhanced physical downlink control channel (EPDCCH) with a first downlink control information (DCI) format for scheduling a first physical downlink shared channel (PDSCH) on the first serving cell. The method additionally includes transmitting a second PDCCH or a second EPDCCH with a second DCI format for scheduling a second PDSCH on the second serving cell. The first DCI format includes a first field indicating a first resource block assignment for the first PDSCH and a second field indicating at least one of first PDSCH starting and ending positions. The second DCI format includes a third field indicating a second resource block assignment for the second PDSCH. A total bit size of the first field and the second field is smaller than or equal to a bit size of the third field.

The 3rd Generation Partnership Project, also referred to as “3GPP,” is a collaboration agreement that aims to define globally applicable technical specifications and technical reports for third and fourth generation wireless communication systems. The 3GPP may define specifications for next generation mobile networks, systems and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE, LTE-Advanced (LTE-A) and other standards (e.g., 3GPP Releases 8, 9, 10, 11 and/or 12). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a user equipment (UE), an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, etc. In 3GPP specifications, a wireless communication device is typically referred to as a UE. However, as the scope of the present disclosure should not be limited to the 3GPP standards, the terms “UE” and “wireless communication device” may be used interchangeably herein to mean the more general term “wireless communication device.”

In 3GPP specifications, a base station is typically referred to as a Node B, an evolved Node B (eNB), a home enhanced or evolved Node B (HeNB) or some other similar terminology. As the scope of the disclosure should not be limited to 3GPP standards, the terms “base station,” “Node B,” “eNB,” and “HeNB” may be used interchangeably herein to mean the more general term “base station.” Furthermore, the term “base station” may be used to denote an access point. An access point may be an electronic device that provides access to a network (e.g., Local Area Network (LAN), the Internet, etc.) for wireless communication devices. The term “communication device” may be used to denote both a wireless communication device and/or a base station.

It should be noted that as used herein, a “cell” may refer to any set of communication channels over which the protocols for communication between a UE and eNB that may be specified by standardization or governed by regulatory bodies to be used for International Mobile Telecommunications-Advanced (IMT-Advanced) or its extensions and all of it or a subset of it may be adopted by 3GPP as licensed bands (e.g., frequency bands) to be used for communication between an eNB and a UE. “Configured cells” are those cells of which the UE is aware and is allowed by an eNB to transmit or receive information. “Configured cell(s)” may be serving cell(s). The UE may receive system information and perform the required measurements on all configured cells. “Activated cells” are those configured cells on which the UE is transmitting and receiving. That is, activated cells are those cells for which the UE monitors the physical downlink control channel (PDCCH) and in the case of a downlink transmission, those cells for which the UE decodes a physical downlink shared channel (PDSCH). “Deactivated cells” are those configured cells that the UE is not monitoring the transmission PDCCH. It should be noted that a “cell” may be described in terms of differing dimensions. For example, a “cell” may have temporal, spatial (e.g., geographical) and frequency characteristics.

The systems and methods disclosed may involve carrier aggregation. Carrier aggregation refers to the concurrent utilization of more than one carrier. In carrier aggregation, more than one cell may be aggregated to a UE. In one example, carrier aggregation may be used to increase the effective bandwidth available to a UE. The same TDD uplink-downlink (UL/DL) configuration has to be used for TDD CA in Release-10, and for intra-band CA in Release-11. In Release-11, inter-band TDD CA with different TDD UL/DL configurations is supported. The inter-band TDD CA with different TDD UL/DL configurations may provide the flexibility of a TDD network in CA deployment. Furthermore, enhanced interference management with traffic adaptation (eIMTA) (also referred to as dynamic UL/DL reconfiguration) may allow flexible TDD UL/DL reconfiguration based on the network traffic load.

It should be noted that the term “concurrent” and variations thereof as used herein may denote that two or more events may overlap each other in time and/or may occur near in time to each other. Additionally, “concurrent” and variations thereof may or may not mean that two or more events occur at precisely the same time.

Licensed-assisted access (LAA) may support LTE in unlicensed spectrum. In a LAA network, the DL transmission may be scheduled in an opportunistic manner. For fairness utilization, an LAA eNB may perform functions such as clear channel assessment (CCA), listen before talk (LBT) and dynamic frequency selection (DFS) before transmission. For example, an eNB may perform LBT for ensuring CCA before transmission. When the eNB performs LBT, the eNB cannot transmit any signals including reference signals.

In License Assisted Access (LAA), using a carrier aggregation (CA) mechanism, the evolved universal mobile telecommunications system terrestrial radio access network (EUTRAN) may be able to use a carrier in unlicensed spectrum as a secondary component carrier. On the other hand, a primary component carrier may have to be a carrier in licensed spectrum. A functionality that may be required for an LAA system is Listen-before-talk (LBT), which may be referred to as clear channel assessment (CCA). The LBT procedure may be defined as a mechanism by which equipment applies a CCA check before using the channel. The CCA may utilize at least energy detection to determine the presence or absence of other signals on a channel in order to determine if a channel is occupied or clear, respectively.

Due to LBT, the eNB may not know whether and/or how to transmit a physical downlink shared channel (PDSCH) until after LBT. Currently, there is no solution on how the control channel is transmitted. The systems and methods disclosed herein provide several methods to solve the problem.

The downlink control information (DCI) format carried by a PDCCH or EPDCCH may have a bit field to indicate starting and/or ending positions of the corresponding PDSCH on an LAA cell as well as resource block assignment field, MCS field and so on. The DCI format may have the same size as a DCI format for scheduling PDSCH on a normal non-LAA cell (e.g., a serving cell on a licensed carrier). The bit sequence that corresponds to Resource allocation header field and/or a Resource block assignment field for the PDSCH on a normal non LAA cell may be used as the bit field to indicate starting and/or ending positions of the corresponding PDSCH on the LAA cell and/or the bit field to indicate resource block assignment with a new Resource allocation type for the PDSCH on the LAA cell.

Various examples of the systems and methods disclosed herein are now described with reference to the Figures, where like reference numbers may indicate functionally similar elements. The systems and methods as generally described and illustrated in the Figures herein could be arranged and designed in a wide variety of different implementations. Thus, the following more detailed description of several implementations, as represented in the Figures, is not intended to limit scope, as claimed, but is merely representative of the systems and methods.

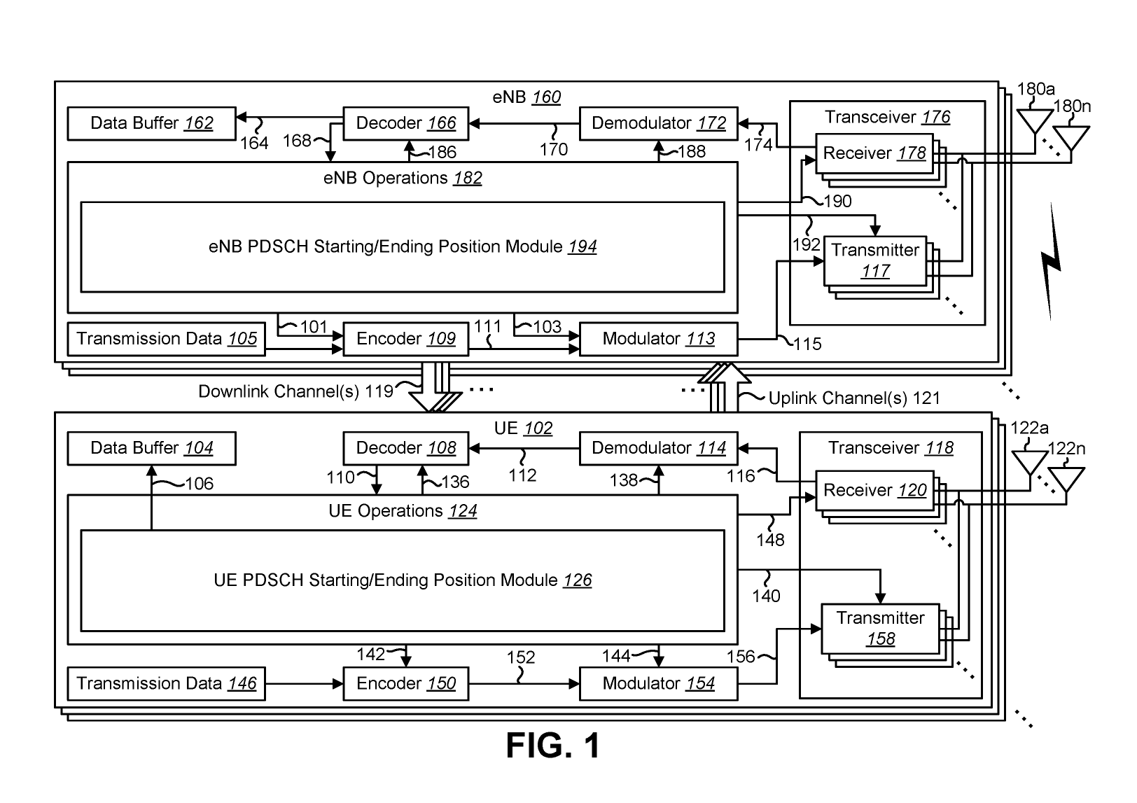

FIG. 1 is a block diagram illustrating one implementation of one or more eNBs 160 and one or more UEs 102 in which systems and methods for LAA may be implemented. The one or more UEs 102 communicate with one or more eNBs 160 using one or more antennas 122a-n. For example, a UE 102 transmits electromagnetic signals to the eNB 160 and receives electromagnetic signals from the eNB 160 using the one or more antennas 122a-n. The eNB 160 communicates with the UE 102 using one or more antennas 180a-n.

The UE 102 and the eNB 160 may use one or more channels 119, 121 to communicate with each other. For example, a UE 102 may transmit information or data to the eNB 160 using one or more uplink channels 121. Examples of uplink channels 121 include a PUCCH and a PUSCH, etc. The one or more eNBs 160 may also transmit information or data to the one or more UEs 102 using one or more downlink channels 119, for instance. Examples of downlink channels 119 include a PDCCH, a PDSCH, etc. Other kinds of channels may be used.

Each of the one or more UEs 102 may include one or more transceivers 118, one or more demodulators 114, one or more decoders 108, one or more encoders 150, one or more modulators 154, a data buffer 104 and a UE operations module 124. For example, one or more reception and/or transmission paths may be implemented in the UE 102. For convenience, only a single transceiver 118, decoder 108, demodulator 114, encoder 150 and modulator 154 are illustrated in the UE 102, though multiple parallel elements (e.g., transceivers 118, decoders 108, demodulators 114, encoders 150 and modulators 154) may be implemented.

The transceiver 118 may include one or more receivers 120 and one or more transmitters 158. The one or more receivers 120 may receive signals from the eNB 160 using one or more antennas 122a-n. For example, the receiver 120 may receive and downconvert signals to produce one or more received signals 116. The one or more received signals 116 may be provided to a demodulator 114. The one or more transmitters 158 may transmit signals to the eNB 160 using one or more antennas 122a-n. For example, the one or more transmitters 158 may upconvert and transmit one or more modulated signals 156.

The demodulator 114 may demodulate the one or more received signals 116 to produce one or more demodulated signals 112. The one or more demodulated signals 112 may be provided to the decoder 108. The UE 102 may use the decoder 108 to decode signals. The decoder 108 may produce decoded signals 110, which may include a UE-decoded signal 106 (also referred to as a first UE-decoded signal 106). For example, the first UE-decoded signal 106 may comprise received payload data, which may be stored in a data buffer 104. Another signal included in the decoded signals 110 (also referred to as a second UE-decoded signal 110) may comprise overhead data and/or control data. For example, the second UE-decoded signal 110 may provide data that may be used by the UE operations module 124 to perform one or more operations.

As used herein, the term “module” may mean that a particular element or component may be implemented in hardware, software or a combination of hardware and software. However, it should be noted that any element denoted as a “module” herein may alternatively be implemented in hardware. For example, the UE operations module 124 may be implemented in hardware, software or a combination of both.

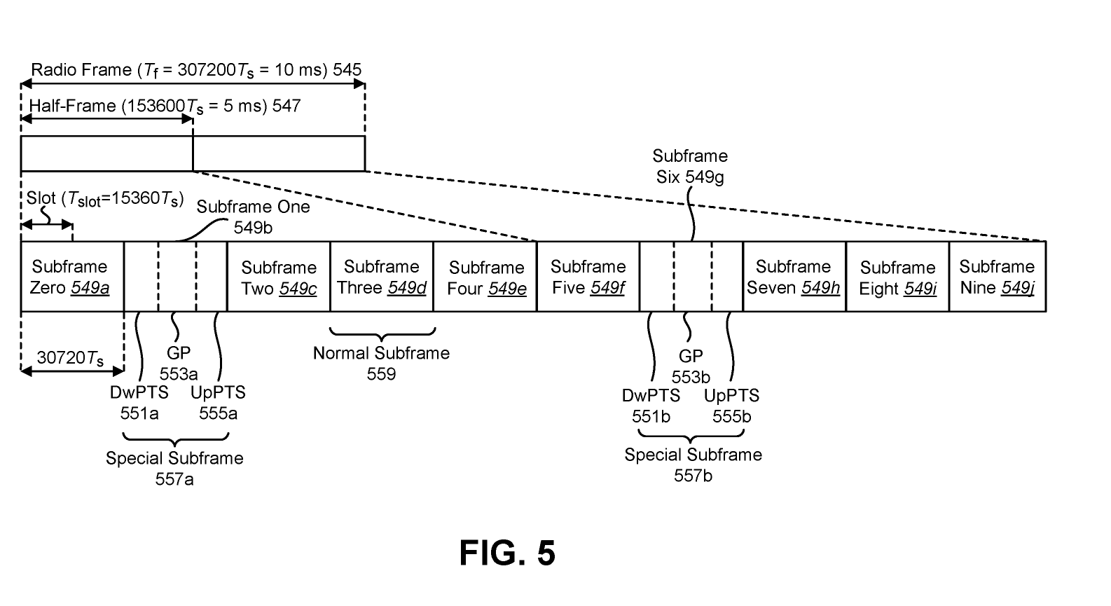

In general, the UE operations module 124 may enable the UE 102 to communicate with the one or more eNBs 160. In some implementations, the UE 102 (e.g., the UE operations module 124) may operate in accordance with a frame structure. One example of a frame structure that may be utilized in accordance with the systems and methods disclosed herein is given in connection with FIG. 5.

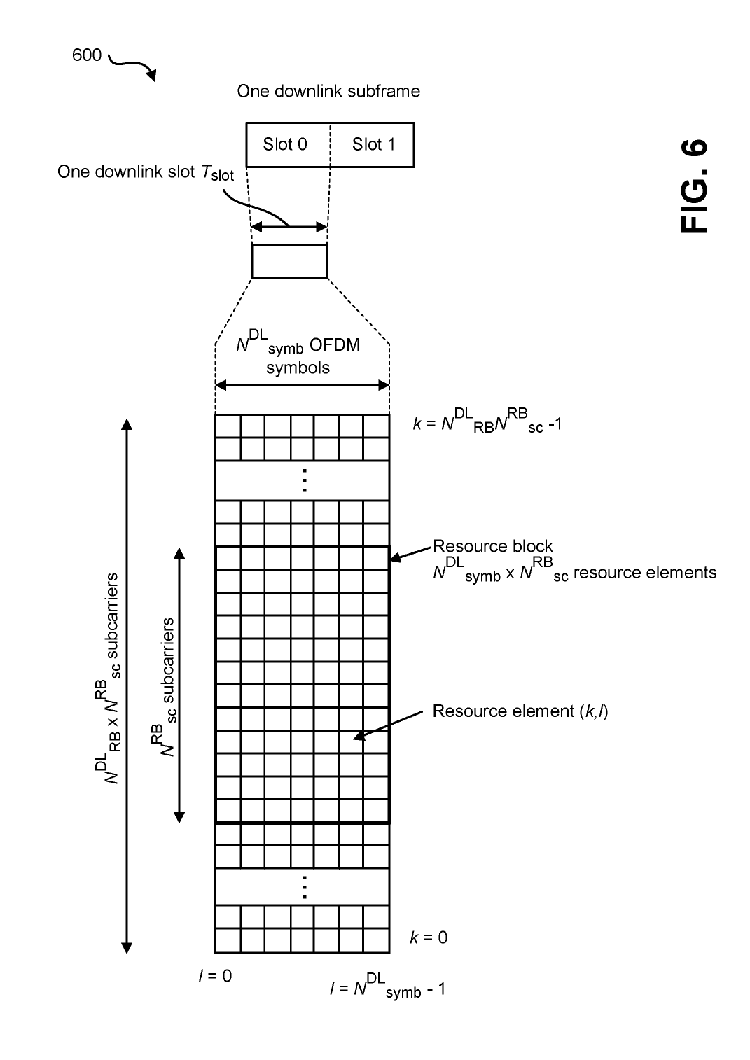

In some implementations, the UE 102 (e.g., the UE operations module 124) may operate in accordance with a resource grid. One example of a resource grid that may be utilized in accordance with the systems and methods disclosed herein is given in connection with FIG. 6.

In the downlink in some implementations, an OFDM access scheme may be employed. In the downlink, for example, a PDCCH, EPDCCH, PDSCH and the like may be transmitted. A downlink radio frame may include multiple pairs of downlink resource blocks (RBs). The downlink RB pair is a unit for assigning downlink radio resources, defined by a predetermined bandwidth (RB bandwidth) and a time slot (two slots (e.g., slot0 and slot1)=one subframe). The downlink RB pair may include two downlink RBs that are continuous in the time domain. The downlink RB may include twelve sub-carriers in the frequency domain and seven (for normal CP) or six (for extended CP) OFDM symbols in time domain. A region defined by one sub-carrier in the frequency domain and one OFDM symbol in the time domain may be referred to as a resource element (RE) and may be uniquely identified by the index pair (k, l) in a slot, where k and l are indices in the frequency and time domains respectively. While downlink subframes in one component carrier (CC) are discussed herein, downlink subframes may be defined for each CC and downlink subframes may be substantially in synchronization with each other among CCs.

As used herein, N^{DL}_{RB} may be a downlink bandwidth configuration of the serving cell, expressed in multiples of N^{RB}_{sc}. N^{RB}_{sc} may be a resource block size in the frequency domain, expressed as a number of subcarriers. N^{DL}_{symb} may be the number of OFDM symbols in a downlink slot. For a PCell, N^{DL}_{RB} may be broadcast as a part of system information. For an SCell (including an LAA SCell), N^{DL}_{RB} may be configured by a RRC message dedicated to a UE. For a PDSCH mapping, an available RE may be the RE whose index l fulfils l≧l_{data,start} and/or l_{data,end}≧l in a subframe.

In carrier aggregation (CA), two or more CCs are aggregated in order to support wider transmission bandwidths (e.g., up to 100 MHz, beyond 100 MHz). A UE may simultaneously receive or transmit on one or multiple CCs. Serving cells can be classified into primary cell (PCell) and secondary cell (SCell). The primary cell may be the cell, operating on the primary frequency, in which the UE either performs the initial connection establishment procedure or initiates the connection re-establishment procedure, or the cell indicated as the primary cell in the handover procedure. A secondary cell may be a cell, operating on a secondary frequency, which may be configured once an RRC connection is established and which may be used to provide additional radio resources. In the downlink, the carrier corresponding to the PCell is the downlink primary component carrier (DL PCC) while in the uplink it is the uplink primary component carrier (UL PCC). Similarly, in the downlink, the carrier corresponding to the SCell is the downlink secondary component carrier (DL SCC) while in the uplink it is the uplink secondary component carrier (UL SCC). The UE may apply the system information acquisition (e.g., acquisition of broadcast system information) and change monitoring procedures for the PCell. For an SCell, E-UTRAN may provide, via dedicated signaling, all system information relevant for operation in RRC_CONNECTED when adding the SCell.

Downlink physical channels and downlink physical signals that may be utilized in accordance with the systems and methods disclosed herein are described as follows. A downlink physical channel may correspond to a set of resource elements carrying information originating from higher layers. The following downlink physical channels may be defined.

Physical downlink shared channel (PDSCH): the PDSCH may carry a transport block provided by a higher layer. The transport block may contain user data, higher layer control messages and/or physical layer system information. A scheduling assignment of PDSCH in a given subframe may normally carried by PDCCH or EPDCCH in the same subframe.

Physical Broadcast Channel (PBCH): the PBCH may carry master information block which is required for an initial access. Physical multicast channel (PMCH): the PMCH may carry MBMS related data and control information.

Physical control format indicator channel (PCFICH): the PCFICH may carry a CFI (control format indicator) specifying the number of OFDM symbols on which PDCCHs are mapped. Physical downlink control channel (PDCCH): the PDCCH may carry a scheduling assignment (which may be referred to as a DL grant) or UL grant. The PDCCH may be transmitted via the same antenna port (CRS port) as PBCH.

Physical hybrid ARQ indicator channel (PHICH): the PHICH may carry UL-associated HARQ-ACK information. Enhanced physical downlink control channel (EPDCCH): the EPDCCH may carry a scheduling assignment or UL grant. The EPDCCH may be transmitted via a different antenna port (DM-RS port) from the PBCH and PDCCH. Possible REs on which EPDCCHs are mapped may be different from those for the PDCCH, though they may partially overlap.

A downlink physical signal may correspond to a set of resource elements used by the physical layer but may not carry information originating from higher layers. One physical signal may be a reference signal (RS). One example of a reference signal (RS) may be a CRS (cell-specific RS). The CRS may be assumed to be transmitted in all downlink subframes and DwPTS. For normal subframe with normal CP, the CRS may be mapped on REs which are located in the first, second and fifth OFDM symbols in each slot. The CRS may be used for demodulation of the PDSCH, CSI measurement and RRM measurement. A CSI-RS may be transmitted in the subframes that are configured by higher layer signaling. The REs on which CSI-RS is mapped may also be configured by higher layer signaling. The CSI-RS may be further classified into NZP (non zero power) CSI-RS and ZP (zero power) CSI-RS. A part of ZP CSI-RS resources may be configured as a CSI-IM resource, which may be used for interference measurement. A UE-RS (UE-specific RS) may be assumed to be transmitted in PRB pairs that are allocated for the PDSCH intended to the UE. The UE-RS may be used for demodulation of the associated PDSCH. A DM-RS (demodulation RS) may be assumed to be transmitted in PRB pairs that are allocated for EPDCCH transmission. The DM-RS may be used for demodulation of the associated EPDCCH.

Another example of a physical signal may be a synchronization signal. Primary and/or secondary synchronization signals may be transmitted to facilitate a UE's cell search, which is the procedure by which the UE acquires time and frequency synchronization with a cell and detects the physical layer Cell ID of that cell. E-UTRA cell search supports a scalable overall transmission bandwidth corresponding to 6 resource blocks and upwards.

Yet another example of a physical signal may be a discovery signal. A discovery signal may include CRS, primary/secondary synchronization signals NZP-CSI-RS (if configured). The UE may assume a discovery signal occasion once every DMTC-Periodicity. The eNB using cell on/off may adaptively turn the downlink transmission of a cell on and off. A cell whose downlink transmission is turned off may be configured as a deactivated SCell for a UE. A cell performing on/off may transmit only periodic discovery signals and UEs may be configured to measure the discovery signals for RRM. A UE may perform RRM measurement and may discover a cell or transmission point of a cell based on discovery signals when the UE is configured with discovery-signal-based measurements.

In some implementations, the UE 102 and/or eNB 160 may operate in accordance with one or more transmission modes. In Rel-12, for example, there are ten transmission modes. These transmission modes may be configurable for an LAA SCell. Examples of transmission modes are given in Table 1.

TABLE 1

| Trans- | | |
|---|---|---|
| mission | | |
| mode | DCI format | Transmission scheme |
| Mode | DCI format 1A | Single antenna port |
| 1 | DCI format 1 | Single antenna port |
| Mode | DCI format 1A | Transmit diversity |
| 2 | DCI format 1 | Transmit diversity |
| Mode | DCI format 1A | Transmit diversity |
| 3 | DCI format 2A | Large delay CDD or Transmit diversity |
| Mode | DCI format 1A | Transmit diversity |
| 4 | DCI format 2 | Closed-loop spatial multiplexing or Transmit |
| | | diversity |
| Mode | DCI format 1A | Transmit diversity |
| 5 | DCI format 1D | Multi-user MIMO |
| Mode | DCI format 1A | Transmit diversity |
| 6 | DCI format 1B | Closed-loop spatial multiplexing using a single |
| | | transmission layer |
| Mode | DCI format 1A | Single-antenna port (for a single CRS port), |
| 7 | | transmit diversity (otherwise) |
| | DCI format 1 | Single-antenna port |
| Mode | DCI format 1A | Single-antenna port (for a single CRS port), |
| 8 | | transmit diversity (otherwise) |
| | DCI format 2B | Dual layer transmission or single-antenna port |
| Mode | DCI format 1A | Single-antenna port (for a single CRS port or |
| 9 | | MBSFN subframe), transmit diversity |
| | | (otherwise) |
| | DCI format 2C | Up to 8 layer transmission or single-antenna |
| | | port |
| Mode | DCI format 1A | Single-antenna port (for a single CRS port or |
| 10 | | MBSFN subframe), transmit diversity |
| | | (otherwise) |
| | DCI format 2D | Up to 8 layer transmission or single-antenna |
| | | port |

The UE 102 and/or the eNB 160 may operate in accordance with one or more DCI formats. In Rel-12, for example, there are sixteen DCI formats. DCI format 1, 1A, 1B, 1C, 1D, 2, 2A, 2B, 2C, and 2D may be used for DL assignment (e.g., DL grant). Examples of DCI formats that may be used in accordance with the systems and methods disclosed herein are given in Table 2.

TABLE 2

| DCI format | Use |
|---|---|
| DCI format 0 | scheduling of PUSCH in one UL cell |
| DCI format 1 | scheduling of one PDSCH codeword in one cell |
| DCI format 1A | compact scheduling of one PDSCH codeword in one cell and random |
| | access procedure initiated by a PDCCH order |
| DCI format 1B | compact scheduling of one PDSCH codeword in one cell with |
| | precoding information |
| DCI format 1C | very compact scheduling of one PDSCH codeword, notifying MCCH |
| | change, and reconfiguring TDD |
| DCI format 1D | compact scheduling of one PDSCH codeword in one cell with |
| | precoding and power offset information |
| DCI format 1A | Transmit diversity |
| DCI format 2 | scheduling of up to two PDSCH codewords in one cell with precoding |
| | information |
| DCI format 2A | scheduling of up to two PDSCH codewords in one cell |
| DCI format 2B | scheduling of up to two PDSCH codewords in one cell with |
| | scrambling identity information |
| DCI format 2C | scheduling of up to two PDSCH codewords in one cell with antenna |
| | port, scrambling identity and number of layers information |
| DCI format 2D | scheduling of up to two PDSCH codewords in one cell with antenna |
| | port, scrambling identity and number of layers information and |
| | PDSCH RE Mapping and Quasi-Co-Location Indicator (PQI) |
| | information |
| DCI format 3 | transmission of TPC commands for PUCCH and PUSCH with 2-bit |
| | power adjustments |
| DCI format 3A | transmission of TPC commands for PUCCH and PUSCH with single |
| | bit power adjustments |
| DCI format 4 | of PUSCH in one UL cell with multi-antenna port transmission mode |
| DCI format 5 | scheduling of PSCCH, and also contains several SCI format 0 fields |
| | used for the scheduling of PSSCH |

DCI formats 1, 1A, 1B, 1C, 1D may include the following bit fields (as illustrated in Table 3-1), where N^{DL}_{RB} is a downlink system band width of the serving cell, which may be expressed in multiples of PRB (physical resource block) bandwidth.

TABLE 3-1

| | DCI F 1 | DCI F 1A | DCI F 1B | DCI F 1C | DCI F 1D |
|---|---|---|---|---|---|
| CIF | 0 or 3 | 0 or 3 | 0 or 3 | N/A | 0 or 3 |
| Flag for format0/1A | N/A | 1 | N/A | N/A | N/A |
| differentiation | | | | | |
| Localized/Distributed | N/A | 1 | 1 | N/A | 1 |
| VRB assignment flag | | | | | |
| Resource allocation | 1 | N/A | N/A | N/A | N/A |
| header | | | | | |
| Gap value | N/A | N/A | N/A | 0 | N/A |
| | | | | (N^{DL}_{RB} < 50) | |
| | | | | or 1 | |
| | | | | (otherwise) | |
| Resource block | Equation 1 | Equation 2 | Equation 2 | Equation 3 | Equation 2 |
| assignment | | | | | |
| Modulation and coding | 5 | 5 | 5 | 5 | 5 |
| scheme | | | | | |
| HARQ process number | 3 (FDD | 3 (FDD | 3 (FDD | N/A | 3 (FDD |
| | PCell) or 4 | PCell) or 4 | PCell) or 4 | | PCell) or 4 |
| | (TDD | (TDD | (TDD | | (TDD |
| | PCell) | PCell) | PCell) | | PCell) |
| New data indicator | 1 | 1 | 1 | N/A | 1 |
| Redundancy version | 2 | 2 | 2 | N/A | 2 |
| TPC command for | 2 | 2 | 2 | N/A | 2 |
| PUCCH | | | | | |
| Downlink Assignment | 0 (FDD | 0 (FDD | 0 (FDD | N/A | 0 (FDD |
| Index | PCell) or 2 | PCell) or 2 | PCell) or 2 | | PCell) or 2 |
| | (otherwise) | (otherwise) | (otherwise) | | (otherwise) |
| SRS request | N/A | 0 or 1 | N/A | N/A | N/A |
| Downlink power offset | N/A | N/A | N/A | N/A | 1 |
| TPMI information for | N/A | N/A | 2 (2 CRS | N/A | 2 (2 CRS |
| precoding | | | ports) or 4 | | ports) or 4 |
| | | | (4 CRS | | (4 CRS |
| | | | ports) | | ports) |
| HARQ-ACK resource | 2 | 2 | 2 | N/A | 2 |
| offset | (EPDCCH) | (EPDCCH) | (EPDCCH) | | (EPDCCH) |
| | or 0 | or 0 | or 0 | | or 0 |
| | (PDCCH) | (PDCCH) | (PDCCH) | | (PDCCH) |

It should be noted that resource block assignment may be performed in accordance with Equation 1: ceil(N^{DL}_{RB}/P) bits, where P is determined from Table 3-2; with Equation 2: ceil(log₂(N^{DL}_{RB} (N^{DL}_{RB}+1)/2)) bits or with Equation 3: ceil(log₂(floor(N^{DL}_{VRB,gap1}/N^{step}_{RB})(floor(N^{DL}_{VRB,gap1}/N^{step}_{RB})+1)/2)) bits, where N^{DL}_{VRB,gap1}=2*min(N_{gap}, N^{DL}_{RB}−N_{gap}).

Table 3-2 illustrates some examples of system bandwidths and corresponding PRG sizes.

TABLE 3-2

| System BW | PRG size |
|---|---|
| N^{DL}_{RB} | P |
| <=10 | 1 |
| 11-26 | 2 |
| 27-63 | 3 |
| 64-110 | 4 |

Table 3-3 illustrates some examples of system bandwidths with corresponding N^{step}_{RB}s.

TABLE 3-3

| System BW | |
|---|---|
| N^{DL}_{RB} | N^{step}_{RB} |
| 6-49 | 2 |
| 50-110 | 4 |

DCI formats 2, 2A, 2B, 2C, 2D may include the following bit fields as given in Table 4.

TABLE 4

| | DCI F 2 | DCI F 2A | DCI F 2B | DCI F 2C | DCI F 2D |
|---|---|---|---|---|---|
| CIF | 0 or 3 | 0 or 3 | 0 or 3 | 0 or 3 | 0 or 3 |
| Resource allocation | 1 | 1 | 1 | 1 | 1 |
| header | | | | | |
| Resource block | Equation 1 | Equation 1 | Equation 1 | Equation 1 | Equation 1 |
| assignment | | | | | |
| TPC command for | 2 | 2 | 2 | 2 | 2 |
| PUCCH | | | | | |
| Downlink Assignment | 0 (FDD | 0 (FDD | 0 (FDD | 0 (FDD | 0 (FDD |
| Index | PCell) or 2 | PCell) or 2 | PCell) or 2 | PCell) or 2 | PCell) or 2 |
| | (otherwise) | (otherwise) | (otherwise) | (otherwise) | (otherwise) |
| HARQ process number | 3 (FDD | 3 (FDD | 3 (FDD | 3 (FDD | 3 (FDD |
| | PCell) or 4 | PCell) or 4 | PCell) or 4 | PCell) or 4 | PCell) or 4 |
| | (TDD | (TDD | (TDD | (TDD | (TDD |
| | PCell) | PCell) | PCell) | PCell) | PCell) |
| Scrambling identity | N/A | N/A | 1 | N/A | N/A |
| Antenna port, | N/A | N/A | N/A | 3 | 3 |
| scrambling identity and | | | | | |
| number of layers | | | | | |
| SRS request | N/A | N/A | 0 or 1 | 0 or 1 | N/A |
| Transport block to | 1 | 1 | N/A | N/A | |
| codeword swap flag | | | | | |
| Modulation and coding | 5 | 5 | 5 | 5 | 5 |
| scheme (TB1) | | | | | |
| New data indicator | 1 | 1 | 1 | 1 | 1 |
| (TB1) | | | | | |
| Redundancy version | 2 | 2 | 2 | 2 | 2 |
| (TB1) | | | | | |
| Modulation and coding | 5 | 5 | 5 | 5 | 5 |
| scheme (TB2) | | | | | |
| New data indicator | 1 | 1 | 1 | 1 | 1 |
| (TB2) | | | | | |
| Redundancy version | 2 | 2 | 2 | 2 | 2 |
| (TB2) | | | | | |
| PDSCH RE Mapping | N/A | N/A | N/A | N/A | 2 |
| and Quasi-Co-Location | | | | | |
| Indicator | | | | | |
| Precoding information | 3 (2 CRS | 0 (2 CRS | N/A | N/A | N/A |
| | ports) or 6 | ports) or 2 | | | |
| | (4 CRS | (4 CRS | | | |
| | ports) | ports) | | | |
| HARQ-ACK resource | 2 | 2 | 2 | 2 | 2 |
| offset | (EPDCCH) | (EPDCCH) | (EPDCCH) | (EPDCCH) | (EPDCCH) |
| | or 0 | or 0 | or 0 | or 0 | or 0 |
| | (PDCCH) | (PDCCH) | (PDCCH) | (PDCCH) | (PDCCH) |

For example, DCI format 2D may have fields as given in Listing 1.
Carrier indicator—0 or 3 bits. The field is present according to the associated RRC configuration.
Resource allocation header (resource allocation type 0/type 1)—1 bit
   If downlink bandwidth is less than or equal to 10 PRBs, there is no resource allocation header and resource allocation type 0 is assumed.
Resource block assignment:
For resource allocation type 0
   ┌N_{RB}^{DL}/P┐ bits provide the resource allocation
For resource allocation type 1
   ┌log₂(P)┐ bits of this field are used as a header specific to this resource allocation type to indicate the selected resource blocks subset
   1 bit indicates a shift of the resource allocation span
   (┌N_{RB}^{DL}/P┐−┌log₂(P)┐−1) bits provide the resource allocation
      where the value of P depends on the number of DL resource blocks
TPC command for PUCCH—2 bits
Downlink Assignment Index —.
HARQ process number—3 bits (for cases with FDD primary cell), 4 bits (for cases with TDD primary cell)
Antenna port(s), scrambling identity and number of layers—3 bits where n_{SCID} is the scrambling identity for antenna ports 7 and 8
SRS request—[0-1] bit.
   In addition, for transport block 1:
Modulation and coding scheme—5 bits
New data indicator—1 bit
Redundancy version—2 bits
   In addition, for transport block 2:
Modulation and coding scheme—5 bits
New data indicator—1 bit
Redundancy version—2 bits
PDSCH RE Mapping and Quasi-Co-Location Indicator—2 bits
HARQ-ACK resource offset (this field is present when this format is carried by EPDCCH. This field is not present when this format is carried by PDCCH)—2 bits. The 2 bits are set to 0 when this format is carried by EPDCCH on a secondary cell, or when this format is carried by EPDCCH on the primary cell scheduling PDSCH on a secondary cell and the UE is configured with PUCCH format 3 for HARQ-ACK feedback.

### Listing 1

More detail is given as follows regarding a resource block assignment field according to DCI format. A resource block assignment field in DCI formats may indicate the PRB set which is used for the corresponding PDSCH transmission. The bit size of the resource block assignment field may depend on the downlink system bandwidth of the serving cell in which the corresponding PDSCH is transmitted. For the existing resource allocation type (e.g., type 0, type 1 and type 2), the bit size may be given in Table 5.

TABLE 5

| | N^{DL}_{RB} = | N^{DL}_{RB} = | N^{DL}_{RB} = | N^{DL}_{RB} = | N^{DL}_{RB} = | N^{DL}_{RB} = |
|---|---|---|---|---|---|---|
| | 6 | 15 | 25 | 50 | 75 | 100 |
| DCI format 1, | 6 | 8 | 13 | 17 | 19 | 25 |
| 2, 2A, 2B, | | | | | | |
| 2C, 2D | | | | | | |
| DCI format | 5 | 7 | 9 | 11 | 12 | 13 |
| 1A, 1B, 1D | | | | | | |
| DCI format | 0 | 4 | 5 | 5 | 6 | 7 |
| 1C | | | | | | |

In resource allocations of type 0 which can be used for DCI format 1, 2, 2A, 2B, 2C and 2D, resource block assignment information may include a bitmap indicating the Resource Block Groups (RBGs) that are allocated to the scheduled UE, where an RBG is a set of consecutive virtual resource blocks (VRBs) of localized type. The bitmap is of size N_{RBG} bits with one bitmap bit per RBG such that each RBG is addressable. The RBGs are indexed in the order of increasing frequency and non-increasing RBG sizes starting at the lowest frequency. The order of RBG to bitmap bit mapping is in such way that RBG 0 to RBG N_{RBG}−1 are mapped to MSB to LSB of the bitmap. The RBG is allocated to the UE if the corresponding bit value in the bitmap is 1, the RBG is not allocated to the UE otherwise. In resource allocations of type 1 which can be used for DCI format 1, 2, 2A, 2B, 2C and 2D, resource block assignment information of size N_{RBG} may indicate to a scheduled UE the VRBs from the set of VRBs from one of P RBG subsets. The virtual resource blocks used may be of localized type. In resource allocations of type 2 which can be used for DCI format 1A, 1B, 1D and 1C, the resource block assignment information may indicate to a scheduled UE a set of contiguously allocated localized virtual resource blocks or distributed virtual resource blocks.

For an LAA serving cell, resource allocations of type 2 for DCI format 1A, 1B and 1D may be used for DCI format 1, 2, 2A, 2B, 2C, 2D as well as DCI format 1A, 1B, 1D. In this case, if N^{DL}_{RB} is greater than or equal to 25, the remaining 4 or more bits in the resource block assignment field of DCI format 1, 2, 2A, 2B, 2C and 2D may be able to be used for the other purpose.

Another approach may be to use resource allocation type 0 with a larger RBG size (e.g., resource allocation type 0 with its PBG size P replaced by P′=ceil(N^{DL}_{RB}/P)). With this approach, the required number of bits for a resource block assignment field may decrease and the remaining bits may be able to be re-utilized for the other purpose.

On the other hand, European regulation may require that the Occupied Channel Bandwidth, e.g., the bandwidth containing 99% of the power of the signal, shall be between 80% and 100% of the declared nominal channel bandwidth. Therefore, it may be preferable that minimum PRBs scheduled for a single UE should be spread over at least 80% of the system bandwidth of the LAA SCell. At the same time, UE multiplexing is an important aspect.

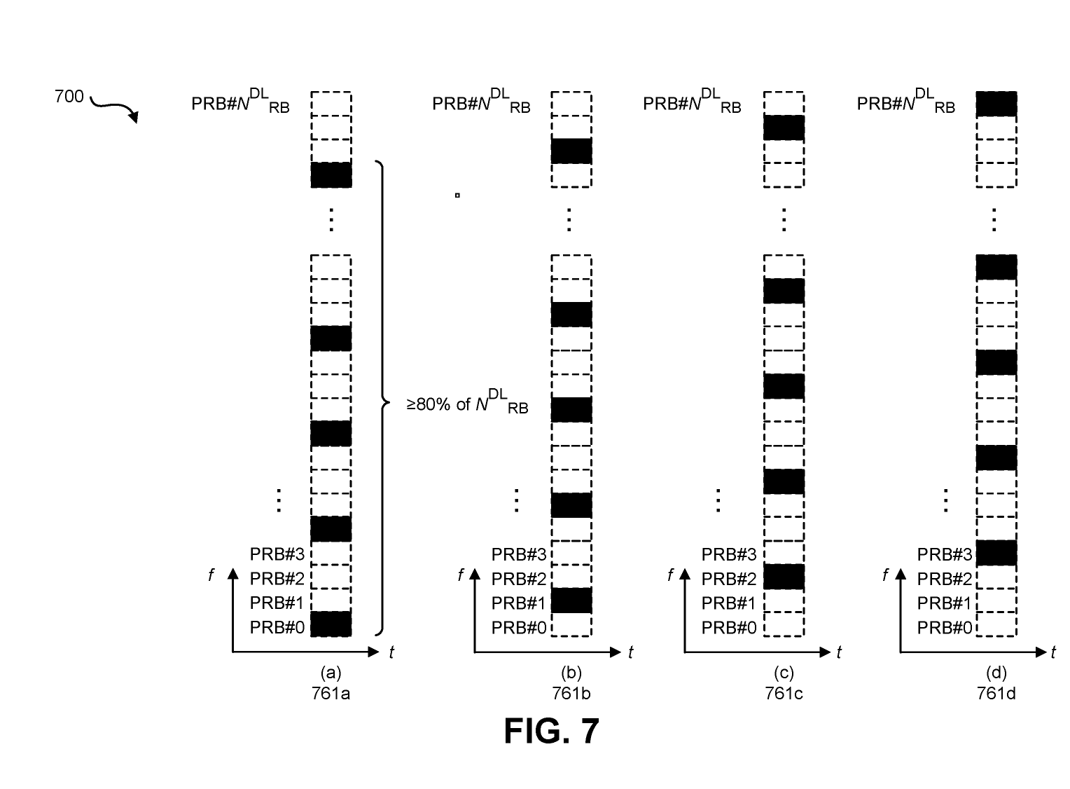

In order to achieve these, a new resource block assignment type (e.g., an interlaced PRB assignment) may be used. Note that the new resource block assignment may also be referred to as type 3 resource block assignment. The PRBs that are located at discrete frequency positions may be grouped. Given that every M PRB in a frequency domain may be included in the same group, M kinds of PRB group (RBG) can be defined. The m-th group may include the PRBs whose indices satisfy “mod(n^{DL}_{RB}, M)=m”, where n^{DL}_{RB} denotes a PRB index (n^{DL}_{RB}, =0, 1, . . . , N^{DL}_{RB}−1) and m may be a PRG index defined as m=0, 1, . . . , M−1. FIG. 7 illustrates one example of interlaced PRB assignment in a case of M=4.

The interlaced PRB assignment may be expressed by M bits. The m-th bit of the M bits may indicate whether or not the m-th PRB group is assigned. In other words, the order of RBG to bitmap bit mapping may be in such way that PRB group 0 to PRB group M−1 may be mapped to MSB to LSB of the bitmap. The PRB group may be allocated to the UE if the corresponding bit value in the bitmap is 1. The PRB group may not be allocated to the UE otherwise. To be more specific, if the m-th bit is 1, the PRBs constituting the m-th PRB group may be assigned to the UE. In contrast, if the m-th bit is 0, the PRBs constituting the m-th PRB group may not be assigned to the UE. Multiple bits of the M bits can be set to 1. In some implementations, each PRB group may satisfy the Occupied Channel Bandwidth requirement. More specifically, M≦N^{DL}_{RB}-ceil(N^{DL}_{RB}*R)+1, where R may be 0.8 or another fixed value greater than 0.8, so that the difference between the highest PRB index and the lowest PRB index within any PRB group is greater than or equal to 80% of N^{DL}_{RB}. With this assignment scheme, any combination of RBG may fulfill the requirement without any kind of transmission of a wideband signal such as CRS, for example. Table 6 gives an example of the minimum possible value of M, which may depend on N^{DL}_{RB}. It should be noted that sub carrier based interleaving may also be applied on top of the interlaced PRB allocation. Alternatively, interlaced sub-carrier based allocation may be applied instead of the interlaced PRB allocation. In this case, the above-described procedure may be reused by replacing “PRB pairs” with “subcarriers.”

TABLE 6

| | N^{DL}_{RB} = | N^{DL}_{RB} = | N^{DL}_{RB} = | N^{DL}_{RB} = | N^{DL}_{RB} = | N^{DL}_{RB} = |
|---|---|---|---|---|---|---|
| | 6 | 15 | 25 | 50 | 75 | 100 |
| Maximum | 2 | 4 | 6 | 11 | 16 | 21 |
| possible | | | | | | |
| M | | | | | | |

One approach is that the bit sizes for the type 3 resource block assignment may be defined as the values shown in Table 6. Another approach is that a set of fixed values greater than the values in Table 6 may be used. For example, M may be set to 4 for N^{DL}_{RB}<50 (N^{DL}_{RB}=6 may not be supported in an LAA carrier) and M is set to 8 for N^{DL}_{RB}≧50. Yet another approach is that a set of fixed values greater than the values in Table 6 may be used. For example, M may be set to 4 for N^{DL}_{RB}<50 (N^{DL}_{RB}=6 may not be supported in an LAA carrier) and M may be set to 4 for N^{DL}_{RB}≧50. Another approach is to take a single value (e.g., M=4) for all kinds of system bandwidth. The same approach may be applied to both of DCI format 1, 2, 2A, 2B, 2C, 2D and DCI format 1A, 1B, 1D. Alternatively, the different approaches may be applied to DCI format 1, 2, 2A, 2B, 2C, 2D and DCI format 1A, 1B, 1D. For example, the values shown in Table 6 may be used for DCI format 1, 2, 2A, 2B, 2C, 2D and, for DCI format 1A, 1B, 1D. M may be set to 4 for N^{DL}_{RB}≦50 and M may be set to 8 for N^{DL}_{RB}>50. In another example, the values shown in Table 6 may be used for DCI format 1, 2, 2A, 2B, 2C, 2D and for DCI format 1A, 1B, 1D. M may be fixed to 4. One or more of these approaches also may save the number of bits for the resource block assignment purpose.

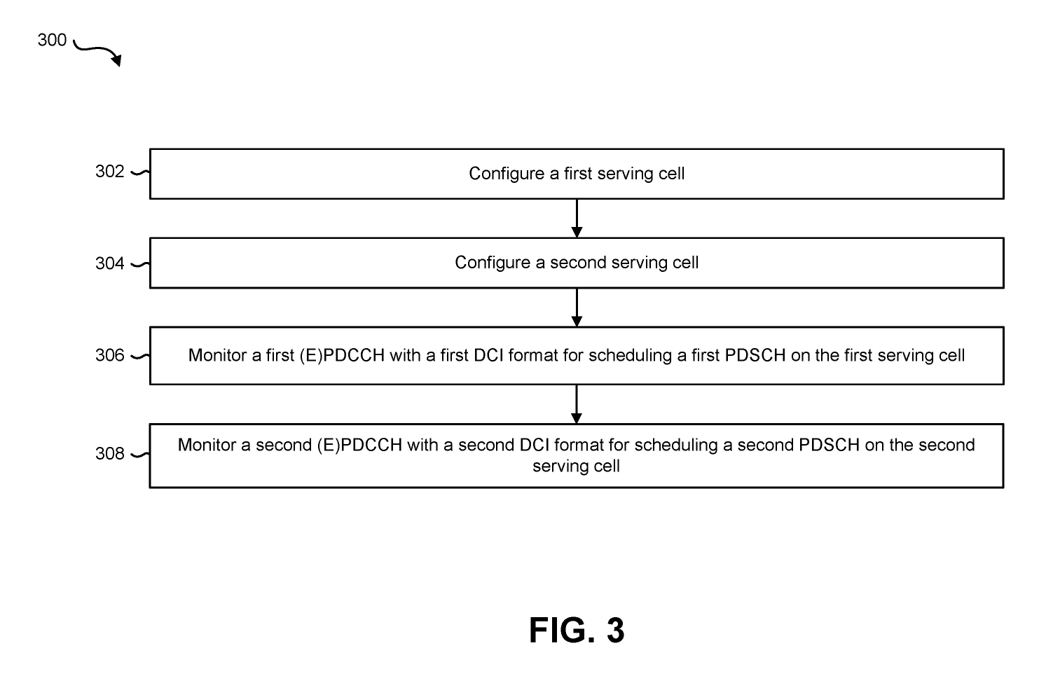

The UE operations module 124 may include a UE PDSCH starting/ending position module 126. A UE PDSCH starting/ending position module 126 may determine the starting and/or ending position(s) for one or more PDSCHs. For example, the UE PDSCH starting/ending position module 126 may determine a starting and/or ending position(s) for one or more PDSCHs in accordance with one or more of the approaches and/or cases described herein. In some configurations, the UE PDSCH starting/ending position module 126 may operate in accordance with the UE behavior described in connection with FIG. 3.

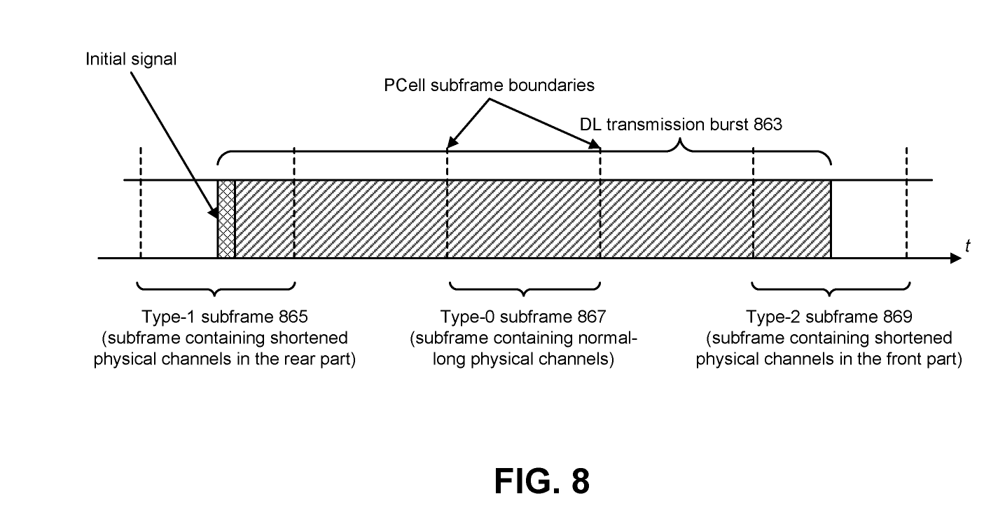

In 3GPP TR 36.899, the DL transmission burst is defined as “Each DL transmission burst is a continuous transmission from a DL transmitting node with no transmission immediately before or after from the same node on the same CC.” In some regions, the length of the DL transmission burst is restricted by regulatory requirements on a maximum channel occupancy time (e.g., 4 ms in Japan and 10 ms in Europe). Even with such kinds of restrictions, the DL transmission burst still can contain several subframes. An example of a DL transmission burst is given in connection with FIG. 8.

A type-0 subframe may contain physical channels/signals, which are mapped to whole OFDM symbols within a subframe. A type-0 subframe may also be referred to as a normal DL subframe in which normal-long physical channels/physical signals are defined in the same manner as with the existing LTE system. For example, for a PDCCH, the starting position may be always the first OFDM symbol in a subframe (e.g., OFDM symbol #0). The ending position may be derived from a CFI (Control Format Indicator), which is carried on PCFICH. For an EPDCCH, the starting position may be either derived from CFI or signaled via a higher layer message such as a dedicated RRC message. The ending position may be always the last OFDM symbol in a subframe (e.g., OFDM symbol #13 for normal CP, OFDM symbol #11 for extended CP). For a PDSCH, the starting position may be either derived from CFI, configured via a higher layer message (e.g., a dedicated RRC message) or dynamically indicated from possible values that are configured via higher layer message. The ending position may be always the last OFDM symbol in a subframe (e.g., OFDM symbol #13 for normal CP, OFDM symbol #11 for extended CP),

For reference signals (CRS, UE-RS, DM-RS, etc.), predefined starting/ending positions may be assumed. Alternatively, in a type-0 subframe physical channels/physical signals may be defined with the following manner. It should be noted that the PDCCH may not be supported in an LAA carrier. For the EPDCCH, the starting position may be always the first OFDM symbol in a subframe (e.g., OFDM symbol #0). The ending position may be always the last OFDM symbol in a subframe (e.g., OFDM symbol #13 for normal CP, OFDM symbol #11 for extended CP). For a PDSCH, a starting position may be always the first OFDM symbol in a subframe (e.g., OFDM symbol #0). The ending position may be always the last OFDM symbol in a subframe (e.g., OFDM symbol #13 for normal CP, OFDM symbol #11 for extended CP). For reference signals (CRS, UE-RS, DM-RS, etc.), predefined starting/ending positions may be assumed.

A type-1 subframe may contain shortened physical channels/signals in its rear part. In its front part, LBT may be performed. The possible starting position of the shortened physical channels/signals may be different from (later than) those of the normal-long physical channels/physical signals. A type-2 subframe may contain shortened physical channels/signals in its front part. The shortened physical channels/signals in a type-2 subframe may end earlier than the rear-side subframe boundary so that total length of DL burst satisfies the regulatory requirement. The type-2 subframe might not need to be defined. In this instance, DL bursts may end with the type-0 subframe and are shorter than the requirement in most cases.

The network may not know starting and ending positions of a DL transmission burst before channel sensing for its contention access. On the other hand, common DRX may be used for both non-LAA and LAA carriers. Hence, the UE 102 also may not know which part of the DL transmission burst contains the subframe in which the UE 102 wakes up. Therefore, it may be beneficial that a unified procedure to derive their starting/ending positions is used irrespective of the subframe type (e.g., type-1, type-2 or type-3 subframe). A simple way may be that the UE 102 monitors multiple (E)PDCCHs that have different starting and ending positions in every subframe, where some of the (E)PDCCHs can be carried in Type-1 subframe and some others can be carried in Type-0 or Type-2 subframe. Then, PDSCH starting/ending positions may be indicated by a field in the DCI format, which is carried by the corresponding (E)PDCCH. There could be several approaches to indicate the PDSCH starting/ending positions.

In a first approach, the DCI format has at least two bit fields, the first bit field is for the starting position and the second bit field is for the ending position. For example, the first bit field may include 2 bits which indicate any one of the possible PDSCH starting positions shown in Table 7-1. The second bit field may include 2 bits which expresses any one of the possible PDSCH ending positions shown in Table 7-2. For simplicity, hereafter, a set of the first bit field and the second fit field is referred as to “PDSCH starting/ending position field.”

TABLE 7-1

| PDSCH starting | Starting OFDM |
|---|---|
| position field | symbol index |
| 0 (‘00’) | 0 (l = 0 in slot0) |
| 1 (‘01') | 4 (l = 4 in slot0) |
| 2 (‘10') | 7 (l = 0 in slot1) |
| 3 (‘11') | 11 (l = 4 in slot1) |

TABLE 7-2

| PDSCH ending | Ending OFDM |
|---|---|
| position field | symbol index |
| 0 (‘00’) | 3 (l = 3 in slot0) |
| 1 (‘01’) | 6 (l = 6 in slot0) |
| 2 (‘10’) | 10 (l = 3 in slot1) |
| 3 (‘11’) | 13 (l = 6 in slot1) |

Instead of Table 7-1, Table 8-1 could be alternatively used. In this case, the subframe may have room for PDCCH/PCFICH transmissions even when the value of the PDSCH starting position field is set to 0.

TABLE 8-1

| PDSCH starting | Starting OFDM |
|---|---|
| position field | symbol index |
| 0 (‘00’) | Follow PQI field if exists, |
| | otherwise follow CFI. |
| 1 (‘01’) | 4 (l = 4 in slot0) |
| 2 (‘10’) | 7 (l = 0 in slot1) |
| 3 (‘11’) | 11 (l = 4 in slot1) |

In a second approach, the DCI format may have at least two bit fields, the first bit field is for indicating subframe type and the second bit field is for indicating either the starting position or that for the ending position. For example, the first bit field may include 2 bits which expresses any one of the possible subframe types shown in Table 9. This field may also indicate how the second field (PDSCH starting/ending position field) should be interpreted. The second bit field may include 2 bits. If the first field indicates the subframe type is type 0, the PDSCH starting position may be always set to 0 (e.g., the very first OFDM symbol in the subframe) or to follow either CFI or PQI, and the PDSCH ending position may be always set to 13 (e.g., the very last OFDM symbol in the subframe). The second bit field may be reserved (e.g., all bits are set to 0).

If the first field indicates the subframe type is type 1, the second bit field may express any one of the possible PDSCH starting positions shown in Table 10-1. The PDSCH ending position may be always set to 13 (e.g., the very last OFDM symbol in the subframe). If the first field indicates the subframe type is type 2, the PDSCH starting position may be always set to 0 (e.g., the very first OFDM symbol in the subframe) or to follow either CFI or PQI. The second bit field may express any one of the possible PDSCH ending positions shown in Table 10-2. Note that, if a type 2 subframe is not adopted, the first field may be 1-bit field which indicate whether type 0 or type 1. For simplicity, hereafter, a set of the first bit field and the second fit field is referred as to “PDSCH starting/ending position field.”

TABLE 9

| Subframe type field | Subframe type |
|---|---|
| 0 (‘00’) | 0 |
| 1 (‘01’) | 1 |
| 2 (‘10’) | 2 |
| 3 (‘11’) | reserved |

TABLE 10-1

| PDSCH | |
|---|---|
| starting/ending | Starting OFDM |
| position field | symbol index |
| 0 (‘00’) | 4 (l = 4 in slot0) |
| 1 (‘01’) | 7 (l = 0 in slot1) |
| 2 (‘10’) | 11 (l = 4 in slot1) |
| 3 (‘11’) | reserved |

TABLE 10-2

| PDSCH | |
|---|---|
| starting/ending | Ending OFDM |
| position field | symbol index |
| 0 (‘00’) | 3 (l = 3 in slot0) |
| 1 (‘01’) | 6 (l = 6 in slot0) |
| 2 (‘10’) | 10 (l = 3 in slot1) |
| 3 (‘11’) | reserved |

In a third approach, the DCI format has at least a single bit field for indicating a combination of the starting position and that for the ending position. For example, this bit field may include 3 bits that express any one of the possible combinations shown in Table 11.

TABLE 11

| PDSCH | | |
|---|---|---|
| starting/ending | Starting OFDM | Ending OFDM |
| position field | symbol index | symbol index |
| 0 (‘000’) | 4 (l = 4 in slot0) | 13 (l = 6 in slot1) |
| 1 (‘001’) | 7 (l = 0 in slot1) | 13 (l = 6 in slot1) |
| 2 (‘010’) | 11 (l = 4 in slot1) | 13 (l = 6 in slot1) |
| 3 (‘011’) | 0 (l = 0 in slot0) | 13 (l = 6 in slot1) |
| 4 (‘100’) | 0 (l = 0 in slot0) | 10 (l = 3 in slot1) |
| 5 (‘101’) | 0 (l = 0 in slot0) | 6 (l = 6 in slot0) |
| 6 (‘110’) | 0 (l = 0 in slot0) | 3 (l = 3 in slot0) |
| 7 (‘111’) | reserved | reserved |

In another example, this bit field may include 4 bits that express any one of the possible combinations shown in Table 12. In this example, the set of the possible numbers of available OFDM symbols for PDSCH mapping is equal to the set of the possible numbers of available OFDM symbols for DwPTS of the existing special subframes for TDD.

TABLE 12

| | | |
|---|---|---|
| PDSCH | | |
| starting/ending | Starting OFDM | Ending OFDM |
| position field | symbol index | symbol index |

| | | | |
|---|---|---|---|
| 0 | (‘0000’) | 0 (l = 0 in slot0) | 2 (l = 2 in slot0) |
| 1 | (‘0001’) | 0 (l = 0 in slot0) | 5 (l = 5 in slot0) |
| 2 | (‘0010’) | 0 (l = 0 in slot0) | 8 (l = 1 in slot1) |
| 3 | (‘0011’) | 0 (l = 0 in slot0) | 9 (l = 2 in slot1) |
| 4 | (‘0100’) | 0 (l = 0 in slot0) | 10 (l = 3 in slot1) |
| 5 | (‘0101’) | 0 (l = 0 in slot0) | 11 (l = 4 in slot1) |
| 6 | (‘0110’) | 0 (l = 0 in slot0) | 13 (l = 6 in slot1) |
| 7 | (‘0111’) | 11 (l = 4 in slot1) | 13 (l = 6 in slot1) |
| 8 | (‘1000’) | 8 (l = 1 in slot1) | 13 (l = 6 in slot1) |
| 9 | (‘1001’) | 5 (l = 5 in slot0) | 13 (l = 6 in slot1) |
| 10 | (‘1010’) | 4 (l = 4 in slot0) | 13 (l = 6 in slot1) |
| 11 | (‘1011’) | 3 (l = 3 in slot0) | 13 (l = 6 in slot1) |
| 12 | (‘1100’) | 2 (l = 2 in slot0) | 13 (l = 6 in slot1) |
| 13 | (‘1101’) | reserved | reserved |
| 14 | (‘1110’) | reserved | reserved |
| 15 | (‘1111’) | reserved | reserved |

In a fourth approach, the DCI format has at least a single bit field for indicating the PDSCH ending position. For example, this bit field may include 2 bits which express any one of the possible combinations shown in Table 7-2. The PDSCH starting position may be indicated by a PQI field.

These PDSCH starting/ending positions may be used for determining available reference signals. To be more specific, the reference signals (e.g., CRS and UE-RS) that are mapped between indicated PDSCH starting/ending positions may be able to be recognized as available reference signals for demodulation of the PDSCH. Also, the reference signals (e.g., CRS, NZP-CSI-RS and/or CSI-IM) that are mapped between indicated PDSCH starting/ending positions may be able to be recognized as available reference signals for CSI measurement. The UE 102 may not be expected to use reference signals outside the region specified by the PDSCH starting/ending positions.

In some configurations of the systems and methods disclosed herein, a resource block assignment field may be replaced. As explained above, DCI format for resource assignment for an LAA serving cell may require the new field for indication of PDSCH RE mapping on top of the existing fields such as TPC command field, MCS field, etc., shown in Table 3-1 and 4.

On the other hand, in some cases, it may be preferable that DCI format size for the LAA serving cell is the same as that for a non-LAA serving cell. For example, given that cross-carrier scheduling for a given LAA SCell is provided from a non-LAA PCell, DCI transmission for the PCell may be allowed on the search spaces of resource assignment for the LAA SCell if the DCI format sizes are the same. This may bring more flexibility on control channel scheduling.

A possible way to fulfill the above two conditions is to replace the existing resource block assignment field with the new resource block assignment field (e.g., type 0 with large PRG sizes, type 3 resource allocation scheme) and the new field(s) (e.g., PDSCH start/end position field, subframe type filed). For example, the replacement may be applied as shown in Table 13. For a non-LAA case (referred to as case 1 herein), DCI format 1, 2, 2A, 2B, 2C, 2D may have an RB assignment field with the size shown in Table 5. For an LAA case (referred to as case 2 here), the bit sequence of the RB assignment field may be interpreted as a combination of the new the RB assignment field and the PDSCH starting/ending position field, each of which has the bit size shown in Table 13. In this example, N_{PDSCH,start/end}, the bit size of PDSCH starting/ending position field, may be set to a fixed value (e.g., 4). The bit size of the RB assignment for DCI format 1, 2, 2A, 2B, 2C, 2D in case 2 may be derived in accordance with Equation 4: min(N^{DL}_{RB}-ceil(N^{DL}_{RB}*R)+1, ceil(N^{DL}_{RB}/P)−N_{PDSCH,start/end}). The bit size of the RB assignment for DCI format 1A, 1B, 1D in case 2 may be derived in accordance with Equation 5: min(N^{DL}_{RB}-ceil(N^{DL}_{RB}*R)+1, ceil(log₂(N^{DL}_{RB} (N^{DL}_{RB}+1)/2))−N_{PDSCH,start/end}). In another example, the replacement may be applied as shown in Table 14. In this example, N_{PDSCH,start/end}, the bit size of PDSCH starting/ending position field, may be set to a fixed value (e.g., 4). The bit size of the RB assignment for DCI format 1, 2, 2A, 2B, 2C, 2D in case 2 may be set to either 4, 8 or 16 depending on N^{DL}_{RB}, while the bit size of the RB assignment for DCI format 1A, 1B, 1D in case 2 may be set to either 4 or 8, depending on N^{DL}_{RB}.

For the same N^{DL}_{RB}, the total bit size of the new the RB assignment field and the PDSCH starting/ending position field may have to be smaller than or equal to (no greater than) the bit size shown in Table 5. If it is smaller, the remaining bits may be reserved (e.g., set to be ‘0’). An example of DCI format 2D is described in Listing 2.

TABLE 13

| | | N^{DL}_{RB} = 25 | N^{DL}_{RB} = 50 | N^{DL}_{RB} = 75 | N^{DL}_{RB} = 100 |
|---|---|---|---|---|---|
| DCI | Case 1 (RB | 13 | 17 | 19 | 25 |
| format 1, | assignment) | | | | |
| 2, 2A, 2B, | Case 2 (RB | 6, 4 | 11, 4 | 15, 4 | 21, 4 |
| 2C, 2D | assignment, | | | | |
| | PDSCH start/end | | | | |
| | position) | | | | |
| DCI | Case 1 (RB | 9 | 11 | 12 | 13 |
| format 1A, | assignment) | | | | |
| 1B, 1D | Case 2 (RB | 5, 4 | 7, 4 | 8, 4 | 9, 4 |
| | assignment, | | | | |
| | PDSCH start/end | | | | |
| | position) | | | | |

TABLE 14

| | | N^{DL}_{RB} = 25 | N^{DL}_{RB} = 50 | N^{DL}_{RB} = 75 | N^{DL}_{RB} = 100 |
|---|---|---|---|---|---|
| DCI | Case 1 (RB | 13 | 17 | 19 | 25 |
| format 1, | assignment) | | | | |
| 2, 2A, 2B, | Case 2 (RB | 4, 4 | 8, 4 | 8, 4 | 16, 4 |
| 2C, 2D | assignment, | | | | |
| | PDSCH start/end | | | | |
| | position) | | | | |
| DCI | Case 1 (RB | 9 | 11 | 12 | 13 |
| format 1A, | assignment) | | | | |
| 1B, 1D | Case 2 (RB | 4, 4 | 4, 4 | 8, 4 | 8, 4 |
| | assignment, | | | | |
| | PDSCH start/end | | | | |
| | position) | | | | |

Carrier indicator—0 or 3 bits. The field is present according to the associated RRC configuration.
Resource allocation header (resource allocation type 0/type 1)—1 bit
   If downlink bandwidth is less than or equal to 10 PRBs, there is no resource allocation header and resource allocation type 0 may be assumed.
   If serving cell c is an LAA cell (If resource allocation scheme type 3 is configured)
Resource block assignment: —min(N^{DL}_{RB}-ceil(N^{DL}_{RB}*R)+1, ceil(N^{DL}_{RB}/P)−N_{PDSCH,start/end}) bits
PDSCH starting/ending position: —N_{PDSCH,start/end} bits
   else
Resource block assignment:
For resource allocation type 0
   ┌N_{RB}^{DL}/P┐ bits provide the resource allocation
For resource allocation type 1
   ┌log₂(P)┐ bits of this field are used as a header specific to this resource allocation type to indicate the selected resource blocks subset
   1 bit indicates a shift of the resource allocation span
   (┌N^{DL}_{RB}/P┐−┌log₂(P)┐−1) bits provide the resource allocation where the value of P depends on the number of DL resource blocks
TPC command for PUCCH—2 bits
Downlink Assignment Index —.
HARQ process number—3 bits (for cases with FDD primary cell), 4 bits (for cases with TDD primary cell)
Antenna port(s), scrambling identity and number of layers—3 bits where n_{SCID} is the scrambling identity for antenna ports 7 and 8
SRS request—[0-1] bit.
   In addition, for transport block 1:
Modulation and coding scheme—5 bits
New data indicator—1 bit
Redundancy version—2 bits
   In addition, for transport block 2:
Modulation and coding scheme—5 bits
New data indicator—1 bit
Redundancy version—2 bits
PDSCH RE Mapping and Quasi-Co-Location Indicator—2 bits
HARQ-ACK resource offset (this field is present when this format is carried by EPDCCH. This field is not present when this format is carried by PDCCH)—2 bits.

### Listing 2

For DCI format 1, 2, 2A, 2B, 2C, 2D, not only the RB assignment field but also resource assignment header field may be replaced with the new resource block assignment field and the new field(s). Moreover, not only the RB assignment field but also Localized/Distributed VRB assignment flag field in DCI format 1A, 1B, 1D may be replaced with the new resource block assignment field and the new field(s). The total bit size of the new the RB assignment field and the new fields including the PDSCH starting/ending position field may have to be smaller than or equal to (no greater than) the total bit size of those existing fields as shown in Table 15. An example of DCI format 2D is described in Listing 3.

TABLE 15

| | | N^{DL}_{RB} = 25 | N^{DL}_{RB} = 50 | N^{DL}_{RB} = 75 | N^{DL}_{RB} = 100 |
|---|---|---|---|---|---|
| DCI | Case 1 (RA | 1, 13 | 1, 17 | 1, 19 | 1, 25 |
| format 1, | header, RB | | | | |
| 2, 2A, 2B, | assignment) | | | | |
| 2C, 2D | Case 2 (RB | 6, 4 | 11, 4 | 16, 4 | 21, 4 |
| | assignment, | | | | |
| | PDSCH start/end | | | | |
| | position) | | | | |
| DCI | Case 1 (L/D VRB | 1, 9 | 1, 11 | 1, 12 | 1, 13 |
| format 1A, | assignment flag, | | | | |
| 1B, 1D | RB assignment) | | | | |
| | Case 2 (RB | 6, 4 | 8, 4 | 9, 4 | 10, 4 |
| | assignment, | | | | |
| | PDSCH start/end | | | | |
| | position) | | | | |

Carrier indicator—0 or 3 bits. The field is present according to the associated RRC configuration.
   If serving cell c is an LAA cell (If resource allocation scheme type 3 is configured)
Resource block assignment: —min(N^{DL}_{RB}-ceil(N^{DL}_{RB}*R)+1, ceil(N^{DL}_{RB}/P)+1−N_{PDSCH,start/end}) bits
PDSCH starting/ending position: —N_{PDSCH,start/end} bits
   else
Resource allocation header (resource allocation type 0/type 1)—1 bit
If downlink bandwidth is less than or equal to 10 PRBs, there is no resource allocation header and resource allocation type 0 is assumed.
Resource block assignment:
For resource allocation type 0
   ┌N_{RB}^{DL}/P┐ bits provide the resource allocation
For resource allocation type 1
   ┌log₂(P)┐ bits of this field are used as a header specific to this resource allocation type to indicate the selected resource blocks subset
   1 bit indicates a shift of the resource allocation span
   (┌N^{DL}_{RB}/P┐−┌log₂(P)┐−1) bits provide the resource allocation
   where the value of P depends on the number of DL resource blocks
TPC command for PUCCH—2 bits
Downlink Assignment Index —.
HARQ process number—3 bits (for cases with FDD primary cell), 4 bits (for cases with TDD primary cell)
Antenna port(s), scrambling identity and number of layers—3 bits where n_{SCID} is the scrambling identity for antenna ports 7 and 8
SRS request—[0-1] bit.
   In addition, for transport block 1:
Modulation and coding scheme—5 bits
New data indicator—1 bit
Redundancy version—2 bits
   In addition, for transport block 2:
Modulation and coding scheme—5 bits
New data indicator—1 bit
Redundancy version—2 bits
PDSCH RE Mapping and Quasi-Co-Location Indicator—2 bits
HARQ-ACK resource offset (this field is present when this format is carried by EPDCCH. This field is not present when this format is carried by PDCCH)—2 bits.

### Listing 3

Another possible approach is to introduce a new DCI format (e.g., DCI format 2E) for LAA serving cells. The new DCI format may include the new resource block assignment field discussed above and the new PDSCH starting/ending position field as well as the existing fields such listed in Table 3-1 and 4, except for the existing resource block assignment field. The new DCI format may be used in a new transmission mode (e.g., TM11), which may be mainly configured in LAA SCell. However, even in the new transmission mode, DCI format 1A may be used. For the DCI format 1A for TM11, the above-described replacement of resource block assignment field may be applied. There may be no need that DCI format 2E size be equal to size of any other DCI format. The DCI format 2E may have fields as listed in Listing 4.
Carrier indicator—0 or 3 bits. The field is present according to the associated RRC configuration.
Resource block assignment: —N_{RB}^{DL}−|N_{RB}^{DL}·R|+1 bits
TPC command for PUCCH—2 bits
Downlink Assignment Index
HARQ process number—3 bits (for cases with FDD primary cell), 4 bits (for cases with TDD primary cell)
Antenna port(s), scrambling identity and number of layers—3 bits where n_{SCID} is the scrambling identity for antenna ports 7 and 8
   In addition, for transport block 1:
Modulation and coding scheme—5 bits
New data indicator—1 bit
Redundancy version—2 bits
   In addition, for transport block 2:
Modulation and coding scheme—5 bits
New data indicator—1 bit
Redundancy version—2 bits
PDSCH RE Mapping and Quasi-Co-Location Indicator—2 bits
HARQ-ACK resource offset (this field is present when this format is carried by EPDCCH. This field is not present when this format is carried by PDCCH)—2 bits. The 2 bits are set to 0 when this format is carried by EPDCCH on a secondary cell, or when this format is carried by EPDCCH on the primary cell scheduling PDSCH on a secondary cell and the UE is configured with PUCCH format 3 for HARQ-ACK feedback.

### Listing 4

Configuration of the replacement may be addressed as follows. Case 1 and case 2 may be differentiated by RRC configuration. One approach is to introduce the information field in a dedicated RRC message that indicates whether the SCell is an LAA cell or not. If the SCell is not an LAA cell, then existing fields are interpreted with the existing way. If the SCell is not an LAA cell, then some of the existing fields in DCI format are interpreted with the different way such as described above. Another approach is to introduce the information field in a dedicated RRC message that indicates whether some of existing fields in DCI format are interpreted with the different way or not. Yet another approach is the interpretation of some of existing fields in DCI format depends on the configured transmission mode for the serving cell. If the UE is configured with TM11 for the serving cell, then the UE may interpret some of the existing fields in DCI format with the above-described way. If the UE is not configured with TM11 (e.g., is configured with any one of TM1 to TM10) for the serving cell, then the UE 102 may interpret existing fields in DCI format with the existing way.

The UE operations module 124 may provide information 148 to the one or more receivers 120. For example, the UE operations module 124 may inform the receiver(s) 120 when to receive retransmissions.

The UE operations module 124 may provide information 138 to the demodulator 114. For example, the UE operations module 124 may inform the demodulator 114 of a modulation pattern anticipated for transmissions from the eNB 160.

The UE operations module 124 may provide information 136 to the decoder 108. For example, the UE operations module 124 may inform the decoder 108 of an anticipated encoding for transmissions from the eNB 160.

The UE operations module 124 may provide information 142 to the encoder 150. The information 142 may include data to be encoded and/or instructions for encoding. For example, the UE operations module 124 may instruct the encoder 150 to encode transmission data 146 and/or other information 142. The other information 142 may include PDSCH HARQ-ACK information.

The encoder 150 may encode transmission data 146 and/or other information 142 provided by the UE operations module 124. For example, encoding the data 146 and/or other information 142 may involve error detection and/or correction coding, mapping data to space, time and/or frequency resources for transmission, multiplexing, etc. The encoder 150 may provide encoded data 152 to the modulator 154.

The UE operations module 124 may provide information 144 to the modulator 154. For example, the UE operations module 124 may inform the modulator 154 of a modulation type (e.g., constellation mapping) to be used for transmissions to the eNB 160. The modulator 154 may modulate the encoded data 152 to provide one or more modulated signals 156 to the one or more transmitters 158.

The UE operations module 124 may provide information 140 to the one or more transmitters 158. This information 140 may include instructions for the one or more transmitters 158. For example, the UE operations module 124 may instruct the one or more transmitters 158 when to transmit a signal to the eNB 160. For instance, the one or more transmitters 158 may transmit during a UL subframe. The one or more transmitters 158 may upconvert and transmit the modulated signal(s) 156 to one or more eNBs 160.

The eNB 160 may include one or more transceivers 176, one or more demodulators 172, one or more decoders 166, one or more encoders 109, one or more modulators 113, a data buffer 162 and an eNB operations module 182. For example, one or more reception and/or transmission paths may be implemented in an eNB 160. For convenience, only a single transceiver 176, decoder 166, demodulator 172, encoder 109 and modulator 113 are illustrated in the eNB 160, though multiple parallel elements (e.g., transceivers 176, decoders 166, demodulators 172, encoders 109 and modulators 113) may be implemented.

The transceiver 176 may include one or more receivers 178 and one or more transmitters 117. The one or more receivers 178 may receive signals from the UE 102 using one or more antennas 180a-n. For example, the receiver 178 may receive and downconvert signals to produce one or more received signals 174. The one or more received signals 174 may be provided to a demodulator 172. The one or more transmitters 117 may transmit signals to the UE 102 using one or more antennas 180a-n. For example, the one or more transmitters 117 may upconvert and transmit one or more modulated signals 115.

The demodulator 172 may demodulate the one or more received signals 174 to produce one or more demodulated signals 170. The one or more demodulated signals 170 may be provided to the decoder 166. The eNB 160 may use the decoder 166 to decode signals. The decoder 166 may produce one or more decoded signals 164, 168. For example, a first eNB-decoded signal 164 may comprise received payload data, which may be stored in a data buffer 162. A second eNB-decoded signal 168 may comprise overhead data and/or control data. For example, the second eNB-decoded signal 168 may provide data (e.g., PDSCH HARQ-ACK information) that may be used by the eNB operations module 182 to perform one or more operations.

In general, the eNB operations module 182 may enable the eNB 160 to communicate with the one or more UEs 102. The eNB operations module 182 may include one or more of an eNB PDSCH starting/ending position module 194.

The eNB PDSCH starting/ending position module 194 may determine the starting and/or ending position for transmitting PDSCH. This may be accomplished as described above. For example, the eNB PDSCH starting/ending position module 194 may determine a starting and/or ending position(s) for one or more PDSCHs in accordance with one or more of the approaches and/or cases described herein. In some configurations, the eNB PDSCH starting/ending position module 194 may operate in accordance with the eNB behavior described in connection with FIG. 3.

The eNB operations module 182 may provide information 188 to the demodulator 172. For example, the eNB operations module 182 may inform the demodulator 172 of a modulation pattern anticipated for transmissions from the UE(s) 102.

The eNB operations module 182 may provide information 186 to the decoder 166. For example, the eNB operations module 182 may inform the decoder 166 of an anticipated encoding for transmissions from the UE(s) 102.

The eNB operations module 182 may provide information 101 to the encoder 109. The information 101 may include data to be encoded and/or instructions for encoding. For example, the eNB operations module 182 may instruct the encoder 109 to encode information 101, including transmission data 105.

The encoder 109 may encode transmission data 105 and/or other information included in the information 101 provided by the eNB operations module 182. For example, encoding the data 105 and/or other information included in the information 101 may involve error detection and/or correction coding, mapping data to space, time and/or frequency resources for transmission, multiplexing, etc. The encoder 109 may provide encoded data 111 to the modulator 113. The transmission data 105 may include network data to be relayed to the UE 102.

The eNB operations module 182 may provide information 103 to the modulator 113. This information 103 may include instructions for the modulator 113. For example, the eNB operations module 182 may inform the modulator 113 of a modulation type (e.g., constellation mapping) to be used for transmissions to the UE(s) 102. The modulator 113 may modulate the encoded data 111 to provide one or more modulated signals 115 to the one or more transmitters 117.

The eNB operations module 182 may provide information 192 to the one or more transmitters 117. This information 192 may include instructions for the one or more transmitters 117. For example, the eNB operations module 182 may instruct the one or more transmitters 117 when to (or when not to) transmit a signal to the UE(s) 102. In some implementations, this may be based on the PSS and SSS. The one or more transmitters 117 may upconvert and transmit the modulated signal(s) 115 to one or more UEs 102.

It should be noted that a DL subframe may be transmitted from the eNB 160 to one or more UEs 102 and that a UL subframe may be transmitted from one or more UEs 102 to the eNB 160. Furthermore, both the eNB 160 and the one or more UEs 102 may transmit data in a standard special subframe.

It should also be noted that one or more of the elements or parts thereof included in the eNB(s) 160 and UE(s) 102 may be implemented in hardware. For example, one or more of these elements or parts thereof may be implemented as a chip, circuitry or hardware components, etc. It should also be noted that one or more of the functions or methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

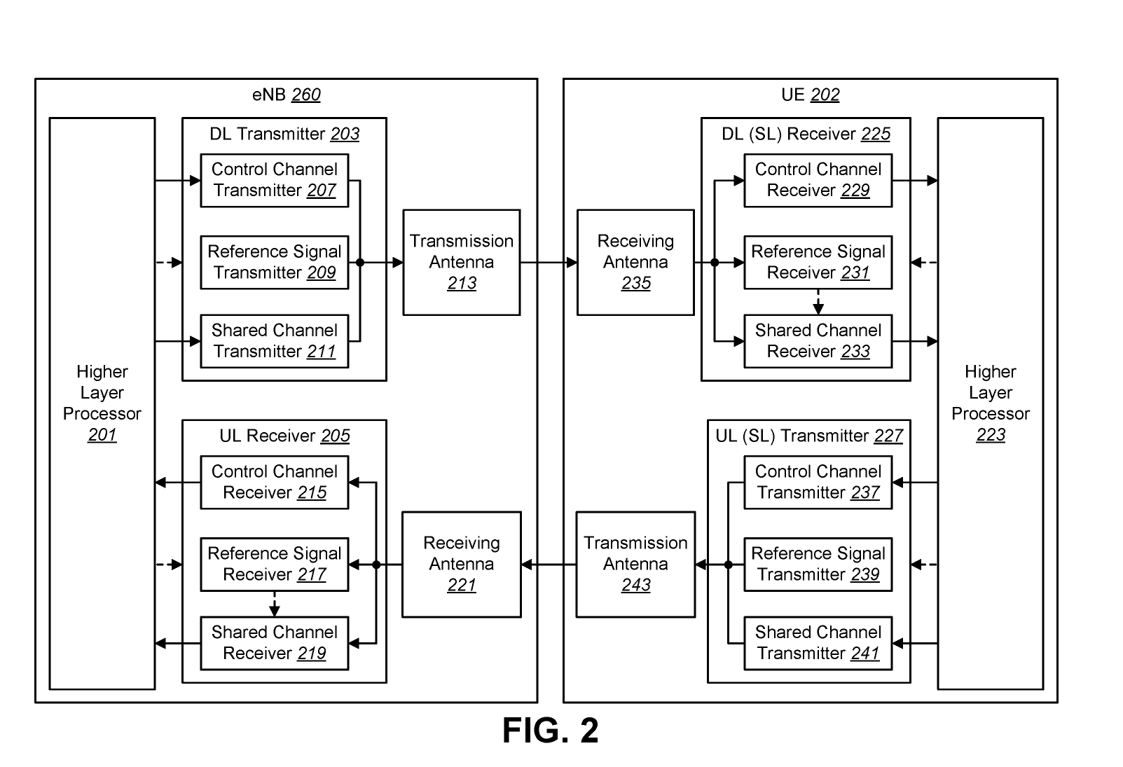

FIG. 2 is block diagram illustrating a detailed configuration of an eNB 260 and a UE 202 in which systems and methods for LAA may be implemented. The eNB 260 may include a higher layer processor 201, a DL transmitter 203 and a UL receiver 205. The higher layer processor 201 may communicate with the DL transmitter 203, UL receiver 205 and subsystems of each.

The DL transmitter 203 may include a control channel transmitter 207, a reference signal transmitter 209 and a shared channel transmitter 211. The DL transmitter 203 may transmit signals/channels to the UE 202 using a transmission antenna 213.

The UL receiver 205 may include a control channel receiver 215, a reference signal receiver 217 and a shared channel receiver 219. The UL receiver 205 may receive signals/channels from the UE 202 using a receiving antenna 221. The reference signal receiver 217 may provide signals to the shared channel receiver 219 based on the received reference signals.

The eNB 260 may configure, in a UE 202, the first serving cell (LAA cell) and the second serving cell (non LAA cell). The configurations may be performed by the higher layer processor 201. The eNB 260 may transmit a (E)PDCCH with the first DCI format for scheduling the first PDSCH in the first serving cell. The (E)PDCCH may be transmitted by control channel transmitter 207. The PDSCH may be transmitted by the shared channel transmitter 211.

The eNB 260 may transmit a (E)PDCCH with the second DCI format for scheduling the second PDSCH in the second serving cell. The control channel transmitter 207 may schedule and/or allocate (E)PDCCHs on the basis of the following bit field size and/or DCI format size.

The first DCI format may include the first field indicating a resource block assignment field and the second field indicating PDSCH starting and/or ending positions. The control channel transmitter 207 may determine the bit size of the first field on the basis of the system bandwidth contained in the first system information. For derivation of the bit size of the first field, an approach in accordance with one or more of Equation 4 and Equation 5 may be used.

The second DCI format may include the third field indicating a resource block assignment but may not include the second field. The control channel transmitter 207 may determine the bit size of the third field on the basis of the system bandwidth contained in the second system information. For derivation of the bit size of the third field, an approach in accordance with one or more of Equation 1, Equation 2 and Equation 3 may be used. It should be noted that Equations 1, 2 and 3 are different from Equations 4 and 5.

For the same N^{DL}_{RB}, the total bit size of the first field and the second field may be smaller than or equal to the third field. For the same N^{DL}_{RB}, the size of the first DCI format may be the same as that of the second DCI format.

The UE 202 may include a higher layer processor 223, a DL (SL) receiver 225 and a UL (SL) transmitter 227. The higher layer processor 223 may communicate with the DL (SL) receiver 225, UL (SL) transmitter 227 and subsystems of each.

The DL (SL) receiver 225 may include a control channel receiver 229, a reference signal receiver 231 and a shared channel receiver 233. The DL (SL) receiver 225 may receive signals/channels from the UE 202 using a receiving antenna 235. The reference signal receiver 231 may provide signals to the shared channel receiver 233 based on the received reference signals. For example, the shared channel receiver 233 may be configured to receive the PDSCH for which the same antenna port is used as for the reference signals.

The UL (SL) transmitter 227 may include a control channel transmitter 237 and a shared channel transmitter 241. The UL (SL) transmitter 227 may send signals/channels to the eNB 260 using a transmission antenna 243.

The UE 202 may configure, by an eNB 260, the first serving cell (LAA cell) and the second serving cell (non LAA cell). The configurations may be performed by the higher layer processor 223. The higher layer processor 223 may acquire the first system information of the first serving cell and the second system information of the second serving cell.

The UE 202 may monitor (e.g., receive/detect) a (E)PDCCH with the first DCI format for scheduling the first PDSCH in the first serving cell. The (E)PDCCH may be monitored by the control channel receiver 229. The PDSCH may be received by the shared channel receiver 233.

The UE 202 may monitor (e.g., receive/detect) a (E)PDCCH with the second DCI format for scheduling the second PDSCH in the second serving cell. The control channel receiver 229 may monitor (E)PDCCHs on the basis of the following bit field size and/or DCI format size.

The first DCI format may include the first field indicating resource block assignment and the second field indicating PDSCH starting and/or ending positions. The control channel receiver may determine the bit size of the first field on the basis of the system bandwidth contained in the first system information. For derivation of the bit size of the first field, an approach in accordance with one or more of Equation 4 and Equation 5 may be used.

The second DCI format may include the third field but may not include the second field. The control channel receiver 229 may determine the bit size of the third field on the basis of the system bandwidth contained in the second system information. For derivation of the bit size of the third field, an approach in accordance with one or more of Equation 1, Equation 2 and Equation 3 may be used. It should be noted that Equations 1, 2 and 3 are different from Equations 4 and 5.

For the same N^{DL}_{RB}, the total bit size of the first field and the second field may be smaller than or equal to the third field. For the same N^{DL}_{RB}, the size of the first DCI format may be the same as that of the second DCI format.

FIG. 3 is a flow diagram illustrating a method 300 for LAA by a UE 102. The UE 102 may configure 302 a first serving cell. This may be accomplished as described herein (e.g., as described in connection with FIG. 1). The UE 102 may configure 304 a second serving cell. This may be accomplished as described herein (e.g., as described in connection with one or more of FIGS. 1 and 2).

The UE 102 may monitor 306 a first (E)PDCCH with a first DCI format for scheduling a first PDSCH on the first serving cell. This may be accomplished as described herein (e.g., as described in connection with one or more of FIGS. 1 and 2).

The UE 102 may monitor 308 a second (E)PDCCH with a second DCI format for scheduling a second PDSCH on the second serving cell. This may be accomplished as described herein (e.g., as described in connection with one or more of FIGS. 1 and 2).

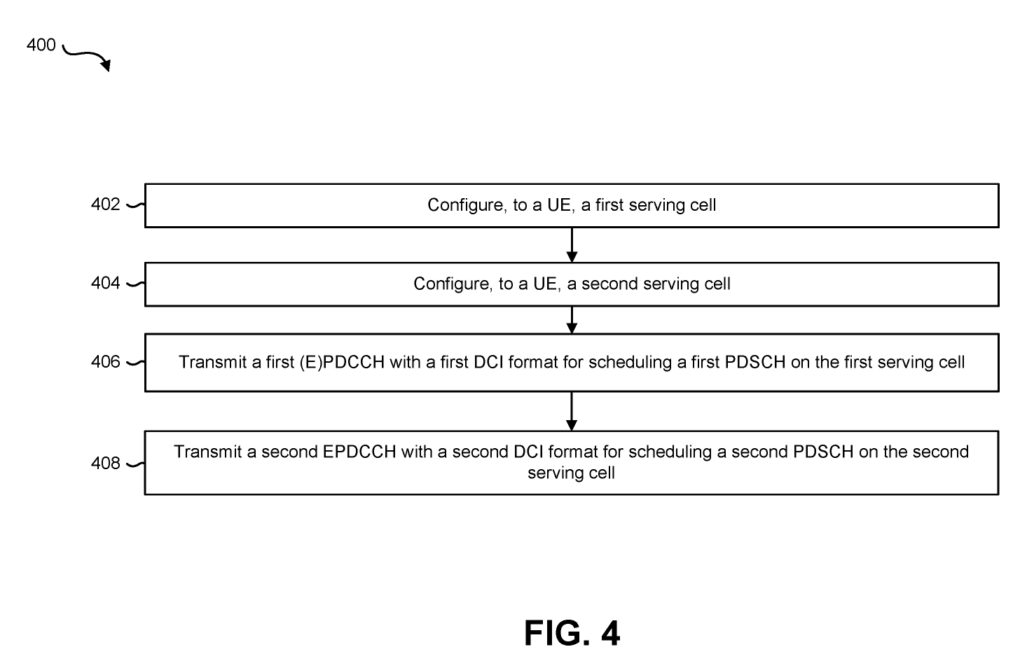

FIG. 4 is a flow diagram illustrating a method 400 for LAA by an eNB 160. The eNB 160 may configure 402, to a UE 102, a first serving cell. This may be accomplished as described herein (e.g., as described in connection with FIG. 1). The eNB 160 may configure 404, to a UE 102, a second serving cell. This may be accomplished as described herein (e.g., as described in connection with one or more of FIGS. 1 and 2).

The eNB 160 may transmit 406 a first (E)PDCCH with a first DCI format for scheduling a first PDSCH on the first serving cell. This may be accomplished as described herein (e.g., as described in connection with one or more of FIGS. 1 and 2).

The eNB 160 may transmit 408 a second (E)PDCCH with a second DCI format for scheduling a second PDSCH on the second serving cell. This may be accomplished as described herein (e.g., as described in connection with one or more of FIGS. 1 and 2).

FIG. 5 is a diagram illustrating one example of a radio frame 545 that may be used in accordance with the systems and methods disclosed herein. This radio frame 545 structure illustrates a TDD structure. Each radio frame 545 may have a length of T_{f}=307200·Tₛ=10 ms, where T_{f} is a radio frame 545 duration and Tₛ is a time unit equal to

$$\frac{1}{( 15000 \times 2048 )} seconds .$$

The radio frame 545 may include two half-frames 547, each having a length of 153600·Tₛ=5 ms. Each half-frame 547 may include five subframes 549a-e, 549f-j each having a length of 30720·Tₛ=1 ms.

TDD UL/DL configurations 0-6 are given below in Table 16 (from Table 4.2-2 in 3GPP TS 36.211). UL/DL configurations with both 5 millisecond (ms) and 10 ms downlink-to-uplink switch-point periodicity may be supported. In particular, seven UL/DL configurations are specified in 3GPP specifications, as shown in Table 16 below. In Table 16, “D” denotes a downlink subframe, “S” denotes a special subframe and “U” denotes a UL subframe.

TABLE 16

| TDD | Downlink- | | | | | | | | | | |
|---|---|---|---|---|---|---|---|---|---|---|---|
| UL/DL | to-Uplink | | | | | | | | | | |
| Configuration | Switch-Point | Subframe Number | | | | | | | | | |
| Number | Periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table 16 above, for each subframe in a radio frame, “D” indicates that the subframe is reserved for downlink transmissions, “U” indicates that the subframe is reserved for uplink transmissions and “S” indicates a special subframe with three fields: a downlink pilot time slot (DwPTS), a guard period (GP) and an uplink pilot time slot (UpPTS). The length of DwPTS and UpPTS is given in Table 17 (from Table 4.2-1 of 3GPP TS 36.211) subject to the total length of DwPTS, GP and UpPTS being equal to 30720·Tₛ=1 ms. In Table 17, “cyclic prefix” is abbreviated as “CP” and “configuration” is abbreviated as “Config” for convenience.

TABLE 17

| | Normal CP in downlink | | | Extended CP in downlink | | |
|---|---|---|---|---|---|---|
| Special | | UpPTS | | | UpPTS | |
| Subframe | | Normal | Extended | | Normal | Extended |
| Config | DwPTS | CP in uplink | CP in uplink | DwPTS | CP in uplink | CP in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | — | — | — |
| 8 | 24144 · Tₛ | | | — | — | — |

UL/DL configurations with both 5 ms and 10 ms downlink-to-uplink switch-point periodicity are supported. In the case of 5 ms downlink-to-uplink switch-point periodicity, the special subframe exists in both half-frames. In the case of 10 ms downlink-to-uplink switch-point periodicity, the special subframe exists in the first half-frame only. Subframes 0 and 5 and DwPTS may be reserved for downlink transmission. UpPTS and the subframe immediately following the special subframe may be reserved for uplink transmission.

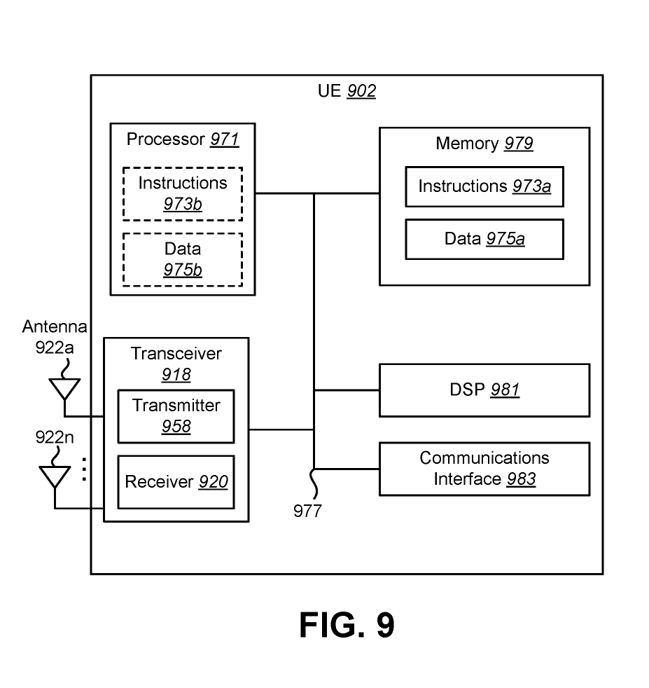

In accordance with the systems and methods disclosed herein, some types of subframes 549 that may be used include a downlink subframe, an uplink subframe and a special subframe 557. In the example illustrated in FIG. 9, which has a 5 ms periodicity, two standard special subframes 557a-b are included in the radio frame 545. The remaining subframes 549 are normal subframes 559.

The first special subframe 557a includes a downlink pilot time slot (DwPTS) 551a, a guard period (GP) 553a and an uplink pilot time slot (UpPTS) 555a. In this example, the first standard special subframe 557a is included in subframe one 549b. The second standard special subframe 557b includes a downlink pilot time slot (DwPTS) 551b, a guard period (GP) 553b and an uplink pilot time slot (UpPTS) 555b. In this example, the second standard special subframe 557b is included in subframe six 549g. The length of the DwPTS 551a-b and UpPTS 555a-b may be given by Table 4.2-1 of 3GPP TS 36.211 (illustrated in Table 17 above) subject to the total length of each set of DwPTS 551, GP 553 and UpPTS 555 being equal to 30720·Tₛ=1 ms.

Each subframe i 549a-j (where i denotes a subframe ranging from subframe zero 549a (e.g., 0) to subframe nine 549j (e.g., 9) in this example) is defined as two slots, 2i and 2i+1 of length Tₛₗₒₜ=15360·Tₛ=0.5 ms in each subframe 549. For example, subframe zero (e.g., 0) 549a may include two slots, including a first slot.

UL/DL configurations with both 5 ms and 10 ms downlink-to-uplink switch-point periodicity may be used in accordance with the systems and methods disclosed herein. FIG. 9 illustrates one example of a radio frame 545 with 5 ms switch-point periodicity. In the case of 5 ms downlink-to-uplink switch-point periodicity, each half-frame 547 includes a standard special subframe 557a-b. In the case of 10 ms downlink-to-uplink switch-point periodicity, a special subframe 557 may exist in the first half-frame 547 only.

Subframe zero (e.g., 0) 549a and subframe five (e.g., 5) 549f and DwPTS 551a-b may be reserved for downlink transmission. The UpPTS 555a-b and the subframe(s) immediately following the special subframe(s) 557a-b (e.g., subframe two 549c and subframe seven 549h) may be reserved for uplink transmission. It should be noted that, in some implementations, special subframes 557 may be considered DL subframes in order to determine a set of DL subframe associations that indicate UCI transmission uplink subframes of a UCI transmission cell.

Downlink and uplink transmissions may be organized into radio frames with 10 ms duration. For frame structure Type 1 (e.g., FDD), each 10 ms radio frame may be divided into ten equally sized sub-frames. Each sub-frame may include two equally sized slots. For frame structure Type 2 (e.g., TDD), each 10 ms radio frame may include two half-frames of 5 ms each. Each half-frame may include eight slots of length 0.5 ms and three special fields: DwPTS, GP and UpPTS. The length of DwPTS and UpPTS may be configurable subject to the total length of DwPTS, GP and UpPTS being equal to 1 ms. Both 5 ms and 10 ms switch-point periodicity may be supported. Subframe 1 in all configurations and subframe 6 in configurations with 5 ms switch-point periodicity may include DwPTS, GP and UpPTS. Subframe 6 in configurations with 10 ms switch-point periodicity may include DwPTS only. All other subframes may include two equally sized slots.

In LTE license access, subframes may be classified into 2 types of subframes. One is the normal subframe that may contain only either one of DL transmission and UL transmission. LTE license access with FDD may only have the normal subframe. The other may be the special subframe that contains three fields DwPTS, GP and UpPTS. DwPTS and UpPTS may be durations reserved for DL transmission and UL transmission, respectively.

LTE license access with TDD can have the special subframe as well as the normal subframe. The lengths of DwPTS, GP and UpPTS can be configured by using a special subframe configuration. Any one of the following ten configurations may be set as a special subframe configuration.

1) Special subframe configuration 0: DwPTS may include 3 OFDM symbols. UpPTS may include 1 single carrier frequency-division multiple access (SC-FDMA) symbol.

2) Special subframe configuration 1: DwPTS may include 9 OFDM symbols for normal CP and 8 OFDM symbols for extended CP. UpPTS may include 1 SC-FDMA symbol.

3) Special subframe configuration 2: DwPTS may include 10 OFDM symbols for normal CP and 9 OFDM symbols for extended CP. UpPTS may include 1 SC-FDMA symbol.

4) Special subframe configuration 3: DwPTS may include 11 OFDM symbols for normal CP and 10 OFDM symbols for extended CP. UpPTS may include 1 SC-FDMA symbol.

5) Special subframe configuration 4: DwPTS may include 12 OFDM symbols for normal CP and 3 OFDM symbols for extended CP. UpPTS may include 1 SC-FDMA symbol for normal CP and 2 SC-FDMA symbols for extended CP.

6) Special subframe configuration 5: DwPTS may include 3 OFDM symbols for normal CP and 8 OFDM symbols for extended CP. UpPTS may include 2 SC-FDMA symbols.

7) Special subframe configuration 6: DwPTS may include 9 OFDM symbols. UpPTS may include 2 SC-FDMA symbols.

8) Special subframe configuration 7: DwPTS may include 10 OFDM symbols for normal CP and 5 OFDM symbols for extended CP. UpPTS may include 2 SC-FDMA symbols.

9) Special subframe configuration 8: DwPTS may include 11 OFDM symbols. UpPTS may include 2 SC-FDMA symbols. Special subframe configuration 8 can be configured only for normal CP

10) Special subframe configuration 9: DwPTS may include 6 OFDM symbols. UpPTS may include 2 SC-FDMA symbols. Special subframe configuration 9 can be configured only for normal CP.

FIG. 6 is a diagram illustrating one example of a resource grid 600. The resource grid 600 illustrated in FIG. 6 may be utilized in some implementations of the systems and methods disclosed herein. More detail regarding the resource grid is given in connection with FIG. 1.

FIG. 7 is a diagram illustrating an example of interlaced PRB assignment 700. Specifically, FIG. 7 illustrates one example of interlaced PRB assignment 700 in a case of M=4. (a) 761a, (b) 761b, (c) 761c and (d) 761d shows grouped PRBs for m=0, 1, 2 and 3, respectively. More detail regarding interlaced PRB assignment is given above in connection with FIG. 1.

FIG. 8 is a diagram illustrating an example of a downlink transmission burst 863. Specifically, FIG. 8 illustrates an example of a DL transmission burst 863 over time. FIG. 8 also illustrates examples of a type-1 subframe 865, a type-0 subframe 867 and a type-2 subframe 869. In this example, the type-1 subframe 865 may contain shortened physical channels (in the rear part of the transmission burst, for instance) and the type-2 subframe 869 may contain shortened physical channels (in the front part of the transmission burst, for instance). Additional detail regarding DL transmission bursts and subframe types is given in connection with FIG. 1.

FIG. 9 illustrates various components that may be utilized in a UE 902. The UE 902 described in connection with FIG. 9 may be implemented in accordance with the UE 102 described in connection with FIG. 1. The UE 902 includes a processor 971 that controls operation of the UE 902. The processor 971 may also be referred to as a central processing unit (CPU). Memory 979, which may include read-only memory (ROM), random access memory (RAM), a combination of the two or any type of device that may store information, provides instructions 973a and data 975a to the processor 971. A portion of the memory 979 may also include non-volatile random access memory (NVRAM). Instructions 973b and data 975b may also reside in the processor 971. Instructions 973b and/or data 975b loaded into the processor 971 may also include instructions 973a and/or data 975a from memory 979 that were loaded for execution or processing by the processor 971. The instructions 973b may be executed by the processor 971 to implement one or more of the methods described above (e.g., the method described in connection with FIG. 3).

The UE 902 may also include a housing that contains one or more transmitters 958 and one or more receivers 920 to allow transmission and reception of data. The transmitter(s) 958 and receiver(s) 920 may be combined into one or more transceivers 918. One or more antennas 922a-n are attached to the housing and electrically coupled to the transceiver 918.

The various components of the UE 902 are coupled together by a bus system 977, which may include a power bus, a control signal bus and a status signal bus, in addition to a data bus. However, for the sake of clarity, the various buses are illustrated in FIG. 9 as the bus system 977. The UE 902 may also include a digital signal processor (DSP) 981 for use in processing signals. The UE 902 may also include a communications interface 983 that provides user access to the functions of the UE 902. The UE 902 illustrated in FIG. 9 is a functional block diagram rather than a listing of specific components.

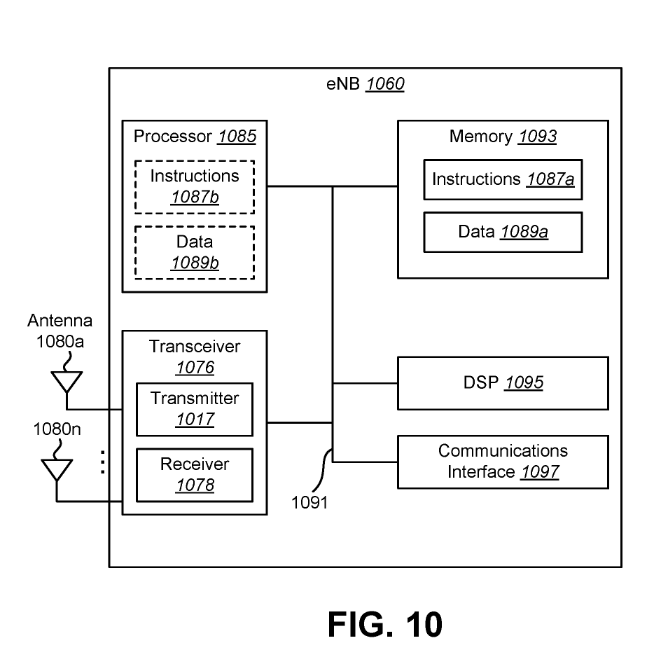

FIG. 10 illustrates various components that may be utilized in an eNB 1060. The eNB 1060 described in connection with FIG. 10 may be implemented in accordance with the eNB 160 described in connection with FIG. 1. The eNB 1060 includes a processor 1085 that controls operation of the eNB 1060. The processor 1085 may also be referred to as a central processing unit (CPU). Memory 1093, which may include read-only memory (ROM), random access memory (RAM), a combination of the two or any type of device that may store information, provides instructions 1087a and data 1089a to the processor 1085. A portion of the memory 1093 may also include non-volatile random access memory (NVRAM). Instructions 1087b and data 1089b may also reside in the processor 1085. Instructions 1087b and/or data 1089b loaded into the processor 1085 may also include instructions 1087a and/or data 1089a from memory 1093 that were loaded for execution or processing by the processor 1085. The instructions 1087b may be executed by the processor 1085 to implement one or more of the methods described above (e.g., the method described in connection with FIG. 4).

The eNB 1060 may also include a housing that contains one or more transmitters 1017 and one or more receivers 1078 to allow transmission and reception of data. The transmitter(s) 1017 and receiver(s) 1078 may be combined into one or more transceivers 1076. One or more antennas 1080a-n are attached to the housing and electrically coupled to the transceiver 1076.

The various components of the eNB 1060 are coupled together by a bus system 1091, which may include a power bus, a control signal bus and a status signal bus, in addition to a data bus. However, for the sake of clarity, the various buses are illustrated in FIG. 10 as the bus system 1091. The eNB 1060 may also include a digital signal processor (DSP) 1095 for use in processing signals. The eNB 1060 may also include a communications interface 1097 that provides user access to the functions of the eNB 1060. The eNB 1060 illustrated in FIG. 10 is a functional block diagram rather than a listing of specific components.

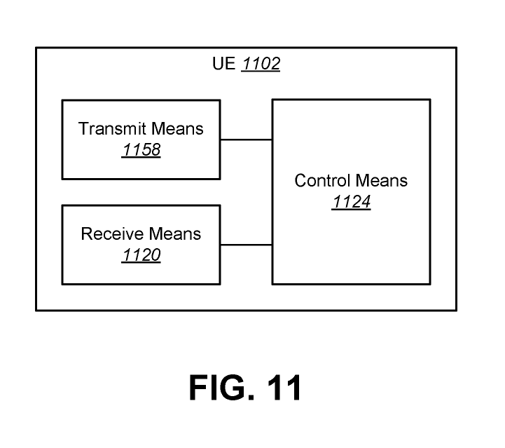

FIG. 11 is a block diagram illustrating one implementation of a UE 1102 in which systems and methods for performing LAA may be implemented. The UE 1102 includes transmit means 1158, receive means 1120 and control means 1124. The transmit means 1158, receive means 1120 and control means 1124 may be configured to perform one or more of the functions described in connection with FIG. 1 above. FIG. 9 above illustrates one example of a concrete apparatus structure of FIG. 11. Other various structures may be implemented to realize one or more of the functions of FIG. 1. For example, a DSP may be realized by software.

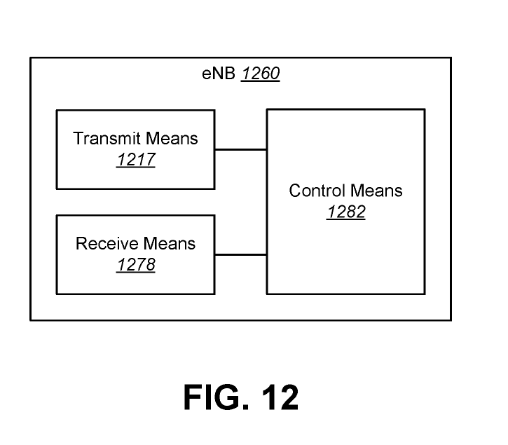

FIG. 12 is a block diagram illustrating one implementation of an eNB 1260 in which systems and methods for performing LAA may be implemented. The eNB 1260 includes transmit means 1217, receive means 1278 and control means 1282. The transmit means 1217, receive means 1278 and control means 1282 may be configured to perform one or more of the functions described in connection with FIG. 1 above. FIG. 10 above illustrates one example of a concrete apparatus structure of FIG. 12. Other various structures may be implemented to realize one or more of the functions of FIG. 1. For example, a DSP may be realized by software.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

A program running on the eNB 160 or the UE 102 according to the described systems and methods is a program (a program for causing a computer to operate) that controls a CPU and the like in such a manner as to realize the function according to the described systems and methods. Then, the information that is handled in these apparatuses is temporarily stored in a RAM while being processed. Thereafter, the information is stored in various ROMs or HDDs, and whenever necessary, is read by the CPU to be modified or written. As a recording medium on which the program is stored, among a semiconductor (for example, a ROM, a nonvolatile memory card, and the like), an optical storage medium (for example, a DVD, a MO, a MD, a CD, a BD, and the like), a magnetic storage medium (for example, a magnetic tape, a flexible disk, and the like), and the like, any one may be possible. Furthermore, in some cases, the function according to the described systems and methods described above is realized by running the loaded program, and in addition, the function according to the described systems and methods is realized in conjunction with an operating system or other application programs, based on an instruction from the program.

Furthermore, in a case where the programs are available on the market, the program stored on a portable recording medium can be distributed or the program can be transmitted to a server computer that connects through a network such as the Internet. In this case, a storage device in the server computer also is included. Furthermore, some or all of the eNB 160 and the UE 102 according to the systems and methods described above may be realized as an LSI that is a typical integrated circuit. Each functional block of the eNB 160 and the UE 102 may be individually built into a chip, and some or all functional blocks may be integrated into a chip. Furthermore, a technique of the integrated circuit is not limited to the LSI, and an integrated circuit for the functional block may be realized with a dedicated circuit or a general-purpose processor. Furthermore, if with advances in a semiconductor technology, a technology of an integrated circuit that substitutes for the LSI appears, it is also possible to use an integrated circuit to which the technology applies.

What is claimed is:

1. A user equipment (UE) comprising:
a higher layer processor configured to configure a first serving cell and a second serving cell; and
a control channel receiver configured to monitor a first physical downlink control channel (PDCCH) or a first enhanced physical downlink control channel (EPDCCH) with a first downlink control information (DCI) format for scheduling a first physical downlink shared channel (PDSCH) on the first serving cell and to monitor a second PDCCH or a second EPDCCH with a second DCI format for scheduling a second PDSCH on the second serving cell;
wherein:
the first DCI format includes a first field indicating a first resource block assignment for the first PDSCH and a second field indicating at least one of first PDSCH starting and ending positions;
the second DCI format includes a third field indicating a second resource block assignment for the second PDSCH, and
a total bit size of the first field and the second field is smaller than or equal to a bit size of the third field.

2. The UE of claim 1, wherein:
a size of the first DCI format is the same as a size of the second DCI format.

3. The UE of claim 1, wherein:
the second field indicates a combination of the starting position and the ending position of the first PDSCH from a plurality of predefined combinations.

4. The UE of claim 1, wherein:
the second field comprises a first sub field and a second sub field,
the first sub field indicates the starting position of the first PDSCH, and
the second sub field indicates the ending position of the first PDSCH.

5. The UE of claim 1, wherein:
the second field includes a first sub field and a second sub field,
the first sub field indicates a subframe type, and
the second sub field indicates one of a starting position and an ending position of the first PDSCH.

6. An evolved NodeB (eNB), comprising:
a higher layer processor configured to configure, to a user equipment (UE), a first serving cell and a second serving cell; and
a physical downlink control channel transmitter configured to transmit a first physical downlink control channel (PDCCH) or a first enhanced physical downlink control channel (EPDCCH) with a first downlink control information (DCI) format for scheduling a first physical downlink shared channel (PDSCH) on the first serving cell and to transmit a second PDCCH or a second EPDCCH with a second DCI format for scheduling a second PDSCH in the second serving cell;
wherein:
the first DCI format includes a first field indicating a first resource block assignment for the first PDSCH and a second field indicating at least one of first PDSCH starting and ending positions,
the second DCI format includes a third field indicating a second resource block assignment for the second PDSCH, and
a total bit size of the first field and the second field is smaller than or equal to a bit size of the third field.

7. The eNB of claim 6, wherein:
a size of the first DCI format is the same as a size of the second DCI format.

8. The eNB of claim 6, wherein:
the second field indicates a combination of the starting position and the ending position of the first PDSCH from a plurality of predefined combinations.

9. The eNB of claim 6, wherein:
the second field comprises a first sub field and a second sub field,
the first sub field indicates the starting position of the first PDSCH, and
the second sub field indicates the ending position of the first PDSCH.

10. The eNB of claim 6, wherein:
the second field includes a first sub field and a second sub field,
the first sub field indicates a subframe type, and
the second sub field indicates one of a starting position and an ending position of the first PDSCH.

11. A method by a user equipment (UE), the method comprising:
configuring a first serving cell;
configuring a second serving cell;
monitoring a first physical downlink control channel (PDCCH) or a first enhanced physical downlink control channel (EPDCCH) with a first downlink control information (DCI) format for scheduling a first physical downlink shared channel (PDSCH) on the first serving cell; and
monitoring a second PDCCH or a second EPDCCH with a second DCI format for scheduling a second PDSCH on the second serving cell;
wherein:
the first DCI format includes a first field indicating a first resource block assignment for the first PDSCH and a second field indicating at least one of first PDSCH starting and ending positions;
the second DCI format includes a third field indicating a second resource block assignment for the second PDSCH, and
a total bit size of the first field and the second field is smaller than or equal to a bit size of the third field.

12. The method of claim 11, wherein:
a size of the first DCI format is the same as a size of the second DCI format.

13. The method of claim 11, wherein:
the second field indicates a combination of the starting position and the ending position of the first PDSCH from a plurality of predefined combinations.

14. The method of claim 11, wherein:
the second field comprises a first sub field and a second sub field,
the first sub field indicates the starting position of the first PDSCH, and
the second sub field indicates the ending position of the first PDSCH.

15. The method of claim 11, wherein:
the second field includes a first sub field and a second sub field,
the first sub field indicates a subframe type, and
the second sub field indicates one of a starting position and an ending position of the first PDSCH.

16. A method by an evolved Node B (eNB), the method comprising:
configuring, to a user equipment (UE), a first serving cell;
configuring, to the UE, a second serving cell;
transmitting a first physical downlink control channel (PDCCH) or a first enhanced physical downlink control channel (EPDCCH) with a first downlink control information (DCI) format for scheduling a first physical downlink shared channel (PDSCH) on the first serving cell; and
transmitting a second PDCCH or a second EPDCCH with a second DCI format for scheduling a second PDSCH on the second serving cell;
wherein:
the first DCI format includes a first field indicating a first resource block assignment for the first PDSCH and a second field indicating at least one of first PDSCH starting and ending positions;
the second DCI format includes a third field indicating a second resource block assignment for the second PDSCH, and
a total bit size of the first field and the second field is smaller than or equal to a bit size of the third field.

17. The method of claim 16, wherein:
a size of the first DCI format is the same as a size of the second DCI format.

18. The method of claim 16, wherein:
the second field indicates a combination of the starting position and the ending position of the first PDSCH from a plurality of predefined combinations.

19. The method of claim 16, wherein:
the second field comprises a first sub field and a second sub field,
the first sub field indicates the starting position of the first PDSCH, and
the second sub field indicates the ending position of the first PDSCH.

20. The method of claim 16, wherein:
the second field includes a first sub field and a second sub field,
the first sub field indicates a subframe type, and
the second sub field indicates one of a starting position and an ending position of the first PDSCH.
